(19) United States
(12) Patent Application Publication
(10) Pub. No.: US 2026/0086628 A1
(43) Pub. Date: Mar. 26, 2026

(54) CONTEXTUAL DIGITAL ASSISTANT RESPONSES

(71) Applicant: Apple Inc., Cupertino, CA (US)

(72) Inventors: William CARUSO, Cupertino, CA (US); Andrew MUEHLHAUSEN, Seattle, WA (US)

(21) Appl. No.: 19/323,652

(22) Filed: Sep. 9, 2025

Related U.S. Application Data
(60) Provisional application No. 63/698,333, filed on Sep. 24, 2024.

(51) Int. Cl. G06F 3/01; G06F 3/16

(52) U.S. Cl. CPC G06F 3/011; G06F 3/167

(57) ABSTRACT

Disclosed herein are example processes for providing action assistance based on nonverbal inputs and low-power context gathering. For example, nonverbal audio events are selected based on context, and in response to detecting an active nonverbal audio event, the user is provided with action assistance based on the detected audio; or, detecting an active audio event triggers the gathering of image context for action assistance.

### CROSS-REFERENCE TO RELATED APPLICATIONS

This application claims priority to U.S. Provisional Patent Application Ser. No. 63/698,333, entitled “CONTEXTUAL DIGITAL ASSISTANT RESPONSES,” filed on Sep. 24, 2024, the contents of which are hereby incorporated by reference in its entirety.

### TECHNICAL FIELD

The present disclosure generally relates to providing three-dimensional audio effects.

### BACKGROUND

The development of computer systems for interacting with and/or providing three-dimensional scenes has expanded significantly in recent years. Example three-dimensional scenes (e.g., environments) include physical scenes and extended reality scenes.

### SUMMARY

Example methods are disclosed herein. An example method includes: at a computer system that is in communication with one or more sensor devices: selecting, based on a first set of contextual information, one or more nonverbal audio events; populating an active set of nonverbal audio events with the one or more nonverbal audio events; detecting, via the one or more sensor devices, first audio data; and in response to detecting the first audio data: in accordance with a determination that the first audio data include a first nonverbal audio event that is included in the active set of nonverbal audio events, performing one or more actions, wherein the one or more actions are based on the first nonverbal audio event.

Example non-transitory computer-readable storage media are disclosed herein. An example non-transitory computer-readable storage medium stores one or more programs. The one or more programs are configured to be executed by one or more processors of a computer system that is in communication with one or more sensor devices. The one or more programs include instructions for: selecting, based on a first set of contextual information, one or more nonverbal audio events; populating an active set of nonverbal audio events with the one or more nonverbal audio events; detecting, via the one or more sensor devices, first audio data; and in response to detecting the first audio data: in accordance with a determination that the first audio data include a first nonverbal audio event that is included in the active set of nonverbal audio events, performing one or more actions, wherein the one or more actions are based on the first nonverbal audio event.

Example computer systems are disclosed herein. An example computer system is configured to communicate with one or more sensor devices. The computer system comprises: one or more processors; and memory storing one or more programs configured to be executed by the one or more processors, the one or more programs including instructions for: selecting, based on a first set of contextual information, one or more nonverbal audio events; populating an active set of nonverbal audio events with the one or more nonverbal audio events; detecting, via the one or more sensor devices, first audio data; and in response to detecting the first audio data: in accordance with a determination that the first audio data include a first nonverbal audio event that is included in the active set of nonverbal audio events, performing one or more actions, wherein the one or more actions are based on the first nonverbal audio event.

An example computer system is configured to communicate with one or more sensor devices. The computer system comprises: means for selecting, based on a first set of contextual information, one or more nonverbal audio events; means for populating an active set of nonverbal audio events with the one or more nonverbal audio events; means for detecting, via the one or more sensor devices, first audio data; and in response to detecting the first audio data: in accordance with a determination that the first audio data include a first nonverbal audio event that is included in the active set of nonverbal audio events, performing one or more actions, wherein the one or more actions are based on the first nonverbal audio event.

Providing action assistance using nonverbal audio detection provides for more intuitive and efficient user-device interaction. Specifically, monitoring audio data to detect contextually-relevant, nonverbal audio events provides a fast, low-power way to trigger action assistance for the user (e.g., using a digital assistant system to perform actions using a computer system), for instance, without requiring the computer system to perform slower or more power-intensive data collection and analysis (e.g., capturing and processing image data). Additionally, activating and responding to contextually-relevant nonverbal audio events (e.g., nonverbal audio events activated based on current context information) additionally reduces latency (e.g., performing actions proactively in response to the nonverbal audio input, without waiting for an explicit user request) and reduces the number of user inputs needed (e.g., to explicitly request action assistance and/or manually perform actions using the computer system) when performing actions. Activating and responding to contextually-relevant nonverbal audio events also improves the accuracy of action assistance, for instance, by providing action assistance only when the detected nonverbal audio trigger indicates a likelihood that the user will want or need action assistance in the current context. In this manner, the user-device interaction is made more efficient and accurate (e.g., by reducing the duration for which the device must be operated to complete a desired task, by helping the user to provide accurate inputs to the device, by reducing the amount of user inputs required to operate the device as desired, and by reducing repeated and/or corrective user inputs if the device does not operate as desired), which in turn reduces power usage and improves battery life of the device by enabling the user to use the device more quickly and efficiently.

Example methods are disclosed herein. An example method includes: at a computer system that is in communication with one or more sensor devices, including one or more audio sensor devices and one or more cameras: retrieving a first set of contextual information; determining a first change to a context state based on the first set of contextual information; in response to determining the first change to the context state, updating, based on the first set of contextual information, an active set of one or more audio events; detecting, via the one or more audio sensors, first audio data; and in response to detecting the first audio data: in accordance with a determination that the first audio data include a first audio event that is included in the active set of one or more audio events: obtaining, via the one or more cameras, first visual information; and performing one or more actions based on the first visual information.

Example non-transitory computer-readable storage media are disclosed herein. An example non-transitory computer-readable storage medium stores one or more programs. The one or more programs are configured to be executed by one or more processors of a computer system that is in communication with one or more sensor devices, including one or more audio sensor devices and one or more cameras. The one or more programs include instructions for: retrieving a first set of contextual information; determining a first change to a context state based on the first set of contextual information; in response to determining the first change to the context state, updating, based on the first set of contextual information, an active set of one or more audio events; detecting, via the one or more audio sensors, first audio data; and in response to detecting the first audio data: in accordance with a determination that the first audio data include a first audio event that is included in the active set of one or more audio events: obtaining, via the one or more cameras, first visual information; and performing one or more actions based on the first visual information.

Example computer systems are disclosed herein. An example computer system is configured to communicate with one or more sensor devices, including one or more audio sensor devices and one or more cameras. The computer system comprises: one or more processors; and memory storing one or more programs configured to be executed by the one or more processors, the one or more programs including instructions for: retrieving a first set of contextual information; determining a first change to a context state based on the first set of contextual information; in response to determining the first change to the context state, updating, based on the first set of contextual information, an active set of one or more audio events; detecting, via the one or more audio sensors, first audio data; and in response to detecting the first audio data: in accordance with a determination that the first audio data include a first audio event that is included in the active set of one or more audio events: obtaining, via the one or more cameras, first visual information; and performing one or more actions based on the first visual information.

An example computer system is configured to communicate with one or more sensor devices, including one or more audio sensor devices and one or more cameras. The computer system comprises: means for retrieving a first set of contextual information; means for determining a first change to a context state based on the first set of contextual information; means for, in response to determining the first change to the context state, updating, based on the first set of contextual information, an active set of one or more audio events; means for detecting, via the one or more audio sensors, first audio data; and means for, in response to detecting the first audio data: in accordance with a determination that the first audio data include a first audio event that is included in the active set of one or more audio events: obtaining, via the one or more cameras, first visual information; and performing one or more actions based on the first visual information.

Providing action assistance using selectively-obtained visual context information provides for more intuitive and efficient user-device interaction. Specifically, monitoring audio data to detect contextually-relevant audio events provides a fast, low-power way to determine whether to provide action assistance based on image data (e.g., visual context information), which reduces the amount of time and power spent collecting and analyzing camera data while still providing the benefits of using visual context for action assistance. Responding to contextually-relevant audio events by capturing and acting based on image data also improves the accuracy of action assistance, for instance, by using multiple different modes of contextual information (e.g., both audio and image data) data to determine, confirm, refine, modify, and/or cancel actions. In this manner, the user-device interaction is made more efficient and accurate (e.g., by reducing the duration for which the device must be operated to complete a desired task, by helping the user to provide accurate inputs to the device, by reducing the amount of user inputs required to operate the device as desired, and by reducing repeated and/or corrective user inputs if the device does not operate as desired), which in turn reduces power usage and improves battery life of the device by enabling the user to use the device more quickly and efficiently. Additionally, selectively obtaining visual context information in response to contextually-relevant audio inputs improves privacy in device interactions, for instance, by limiting the collection of camera data to only when the camera data will be most relevant, useful, and/or appropriate to action assistance.

In some examples, the computer system is a desktop computer with an associated display. In some examples, the computer system is a portable device (e.g., a notebook computer, tablet computer, or handheld device such as a smartphone). In some examples, the computer system is a personal electronic device (e.g., a wearable electronic device, such as a watch or a head-mounted device). In some examples, the computer system has a touchpad. In some examples, the computer system has one or more cameras. In some examples, the computer system has a display generation component (e.g., a display device such as a head-mounted display, a display, a projector, a touch-sensitive display (also known as a “touch screen” or “touch-screen display”), or other device or component that presents visual content to a user, for example on or in the display generation component itself or produced from the display generation component and visible elsewhere). In some examples, the computer system does not have a display generation component and does not present visual content to a user. In some examples, the computer system has a touch-sensitive display (also known as a “touch screen” or “touch-screen display”). In some examples, the computer system has one or more eye-tracking components. In some examples, the computer system has one or more hand-tracking components. In some examples, the computer system has one or more output devices, the output devices including one or more tactile output generators and/or one or more audio output devices. In some examples, the computer system has one or more processors, memory, and one or more modules, programs or sets of instructions stored in the memory for performing various functions described herein. In some examples, the user interacts with the computer system through a stylus and/or finger contacts and gestures on the touch-sensitive surface, movement of the user's eyes and hand in space or the user's body as captured by cameras and other movement sensors, and/or voice inputs as captured by one or more audio input devices. Executable instructions for performing these functions are, optionally, included in a transitory and/or non-transitory computer-readable storage medium or other computer program product configured for execution by one or more processors.

Note that the various examples described above can be combined with any other examples described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described examples, reference should be made to the Detailed Description below, in conjunction with the following drawings in which like reference numerals refer to corresponding parts throughout the figures.

FIG. 1 is a block diagram illustrating an operating environment of a computer system for interacting with three-dimensional (3D) scenes, according to some examples.

FIG. 2 is a block diagram of a user-facing component of the computer system, according to some examples.

FIG. 3 is a block diagram of a controller of the computer system, according to some examples.

FIG. 4 illustrates an architecture for a foundation model, according to some examples.

FIGS. 5A-5I illustrate action assistance using a digital assistant, according to some examples.

FIG. 6 is a flow diagram of a method for providing action assistance using nonverbal audio detection, according to some examples.

FIG. 7 is a flow diagram of a method for providing low-power action assistance using contextual information, according to some examples.

### DETAILED DESCRIPTION

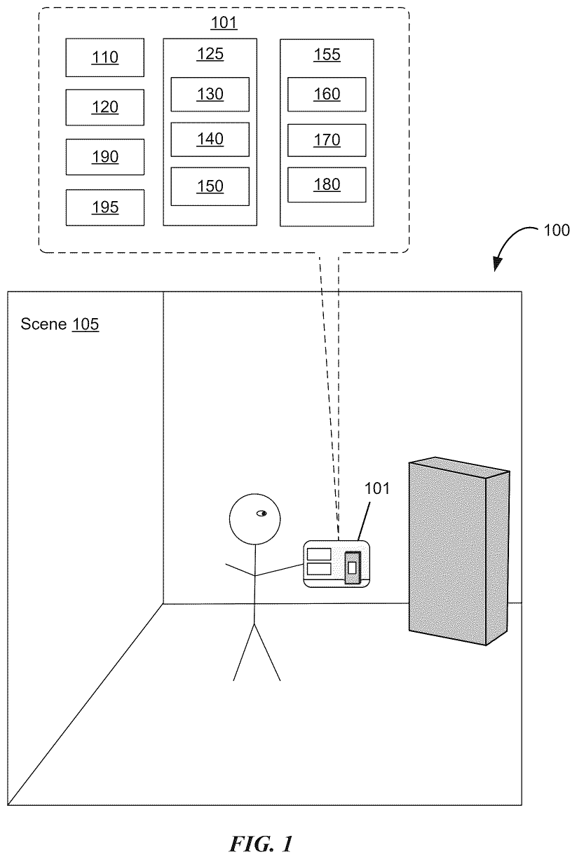

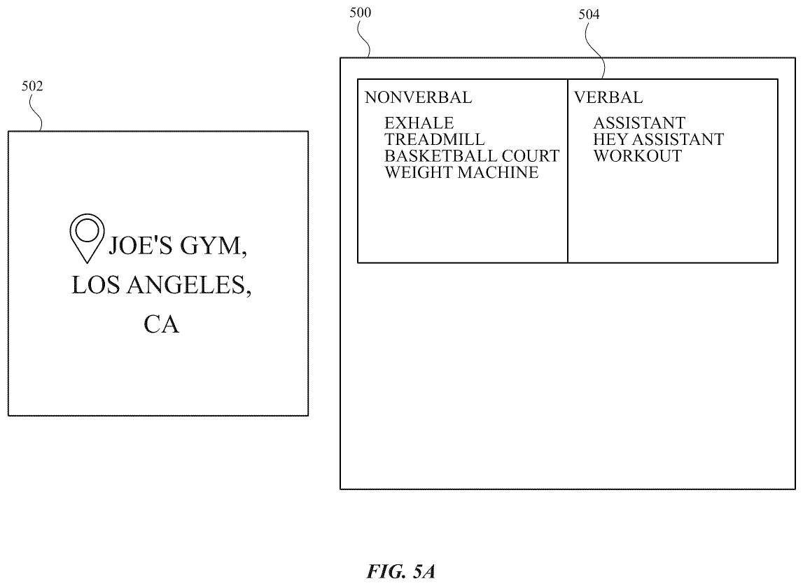

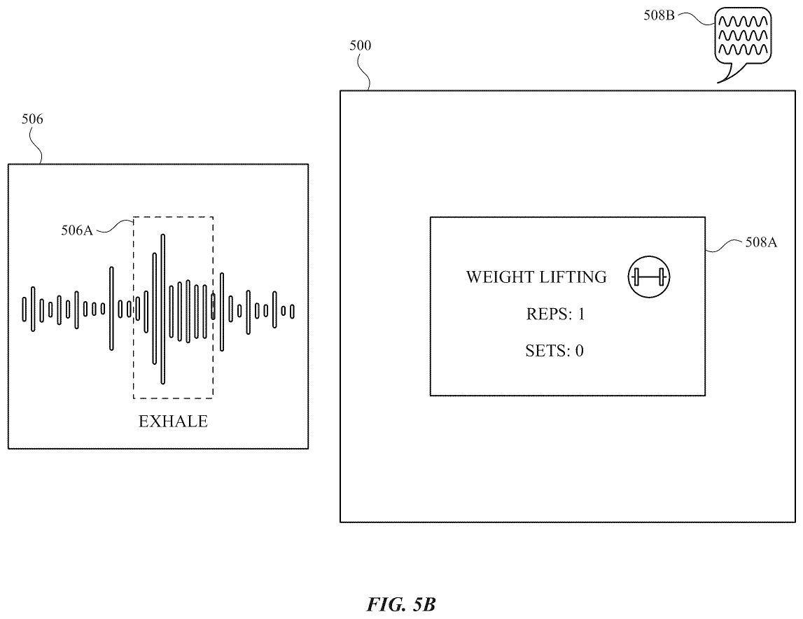

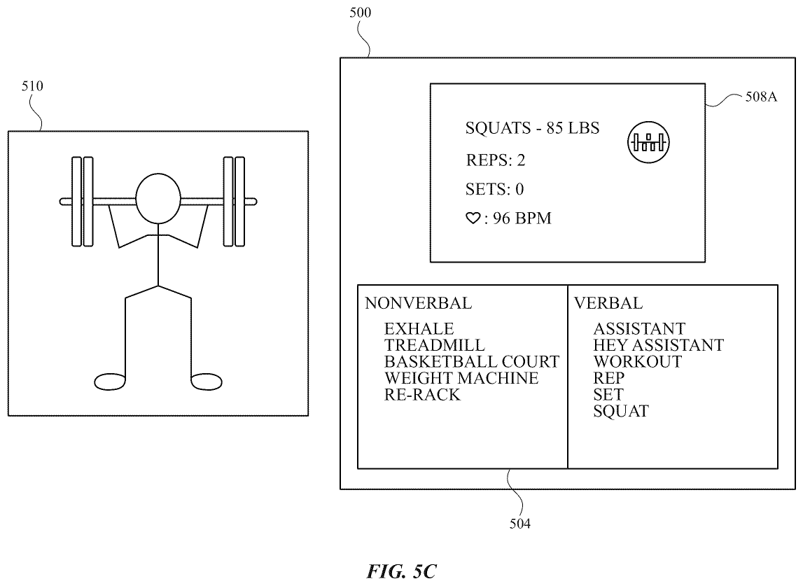

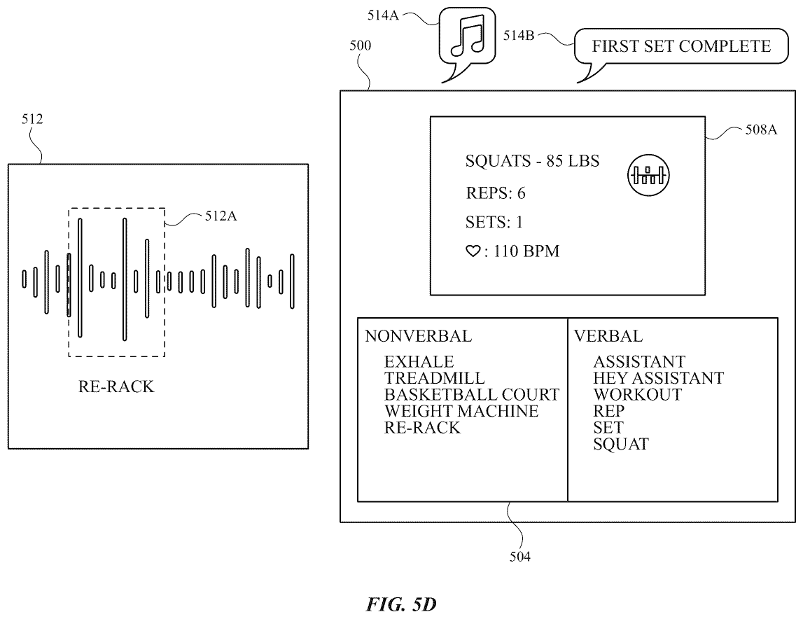

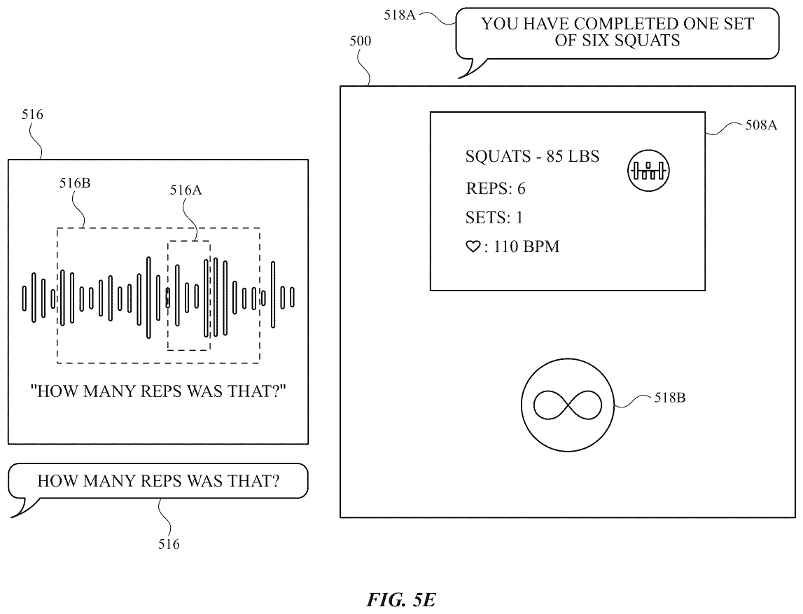

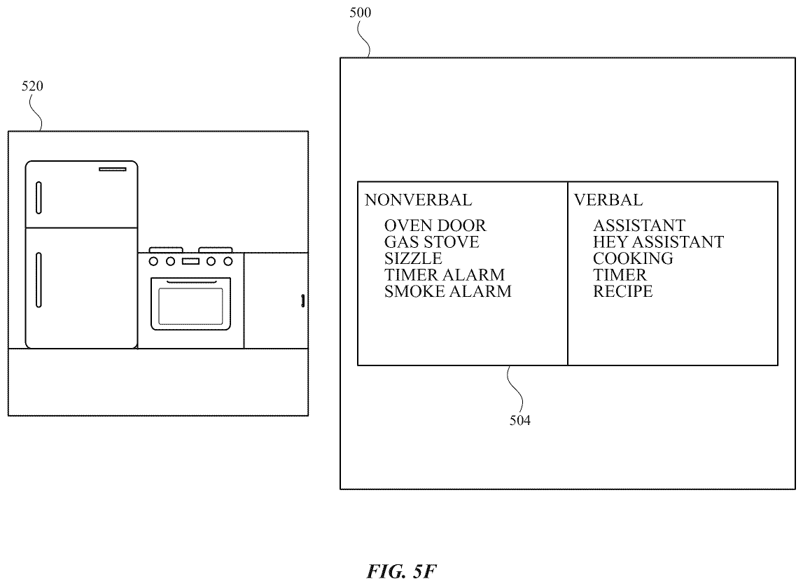

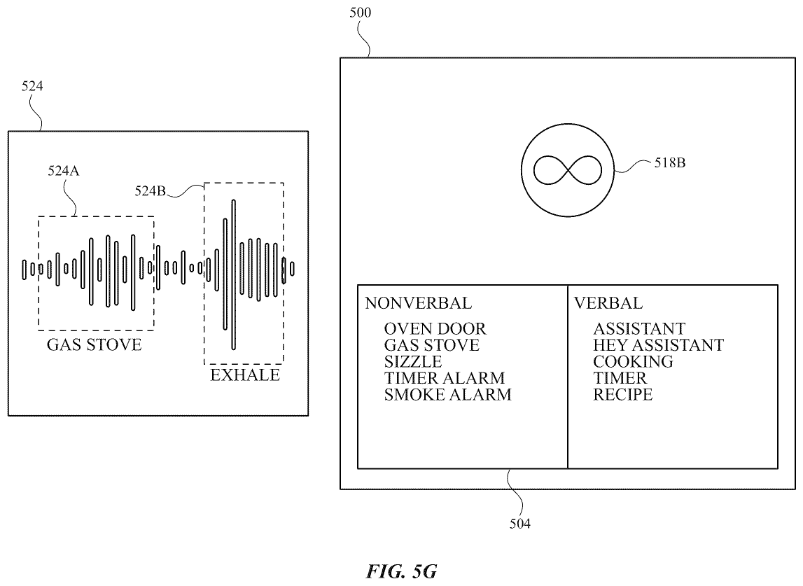

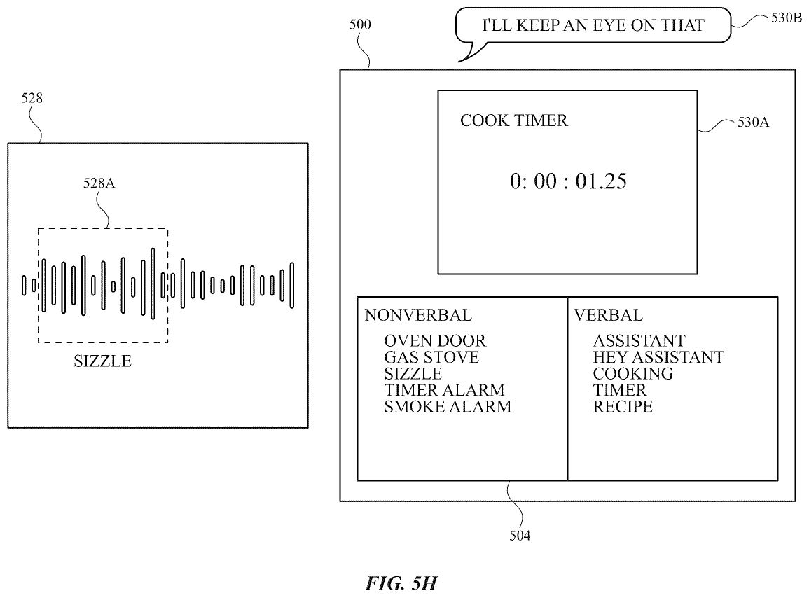

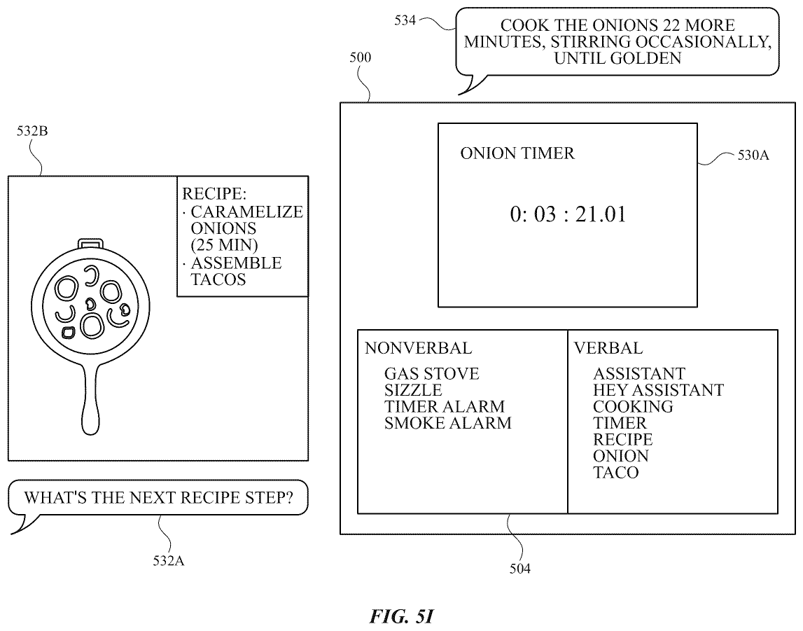

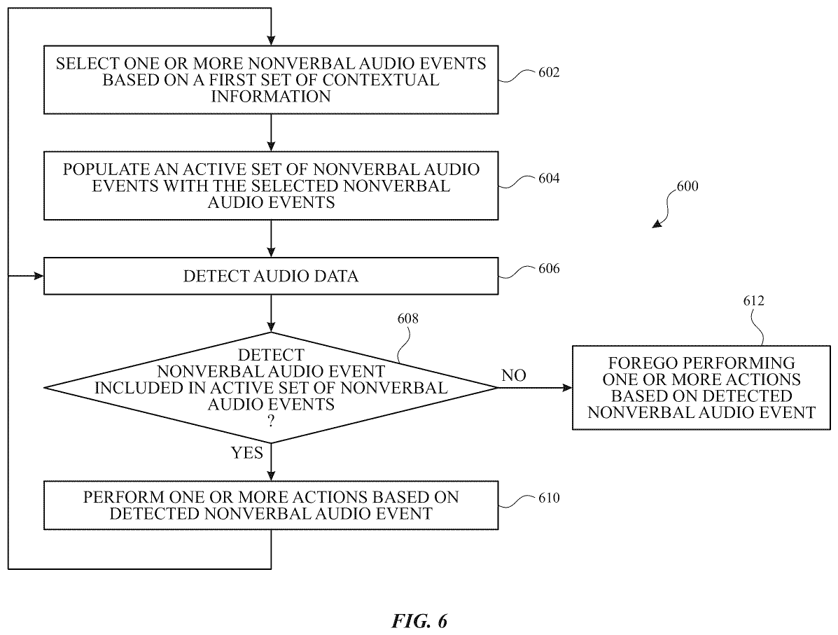

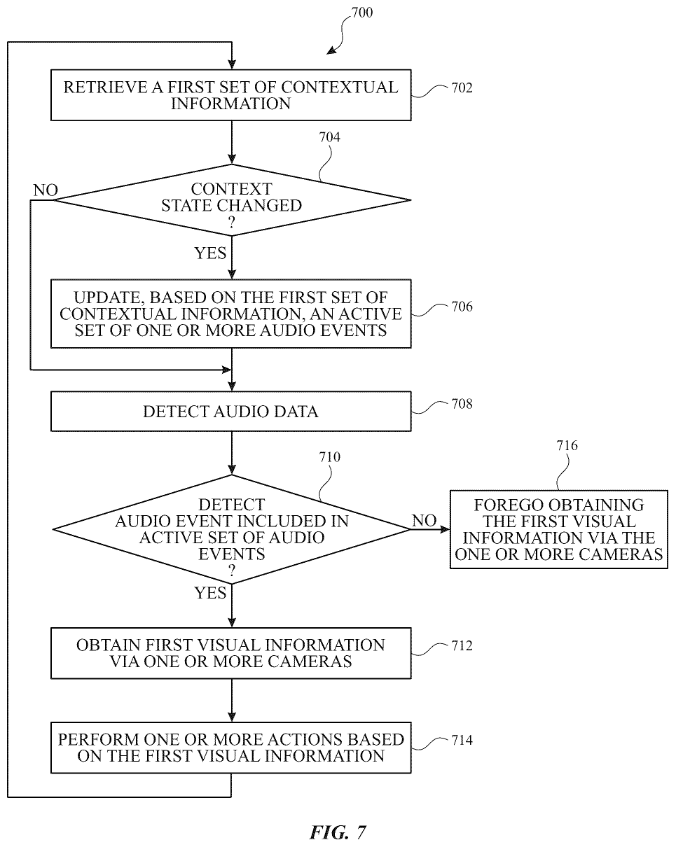

FIGS. 1-4 provide a description of example computer systems and techniques for interacting with three-dimensional scenes. FIGS. 5A-51 illustrate examples of action assistance using a digital assistant. FIG. 6 is a flow diagram of a method for providing action assistance using nonverbal audio detection. FIG. 7 is a flow diagram of a method for providing low-power action assistance using contextual information. FIGS. 5A-5I are used to describe the methods of FIGS. 6-7.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer-readable medium claims where the system or computer-readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer-readable storage medium can repeat the steps of a method as many times as are needed to ensure that all of the contingent steps have been performed.

FIG. 1 is a block diagram illustrating an operating environment of computer system 101 for interacting with three-dimensional scenes, according to some examples. In FIG. 1, a user interacts with three-dimensional scene 105 via operating environment 100 that includes computer system 101. In some examples, computer system 101 includes controller 110 (e.g., processors of a portable electronic device or a remote server), user-facing component 120, one or more input devices 125 (e.g., eye tracking device 130, hand tracking device 140, and/or other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, audio sensors, etc.), and one or more peripheral devices 195 (e.g., home appliances, wearable devices, etc.). In some examples, one or more of input devices 125, output devices 155, sensors 190, and peripheral devices 195 are integrated with user-facing component 120 (e.g., in a head-mounted device or a handheld device).

While pertinent features of the operating environment 100 are shown in FIG. 1, those of ordinary skill in the art will appreciate from the present disclosure that various other features have not been illustrated for the sake of brevity and so as not to obscure more pertinent aspects of the examples disclosed herein.

Hardware: There are many different types of electronic systems that enable a person to sense and/or interact with three-dimensional scenes. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). Alternatively, a head-mounted system may be configured to operate without displaying content, e.g., so that the head-mounted system provides output to a user via tactile and/or auditory means. The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one example, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

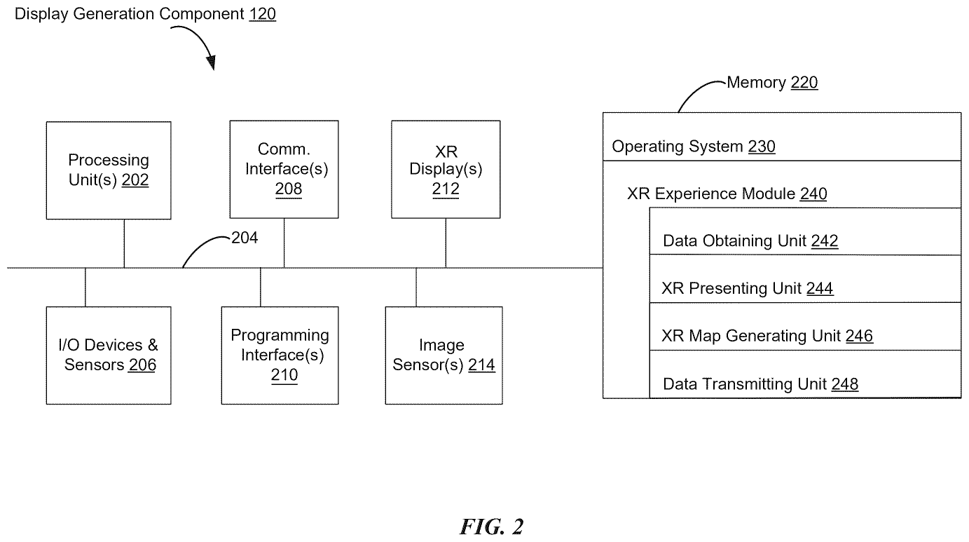

In some examples, user-facing component 120 is configured to provide a visual component of a three-dimensional scene. In some examples, user-facing component 120 includes a suitable combination of software, firmware, and/or hardware. User-facing component 120 is described in greater detail below with respect to FIG. 2. In some examples, the functionalities of controller 110 are provided by and/or combined with user-facing component 120. In some examples, user-facing component 120 provides an extended reality (XR) experience to the user while the user is virtually and/or physically present within scene 105.

In some examples, user-facing component 120 is worn on a part of the user's body (e.g., on his/her head, on his/her hand, etc.). In some examples, user-facing component 120 includes one or more XR displays provided to display the XR content. In some examples, user-facing component 120 encloses the field-of-view of the user. In some examples, user-facing component 120 is a handheld device (such as a smartphone or tablet) configured to present XR content, and the user holds the device with a display directed towards the field-of-view of the user and a camera directed towards the scene 105. In some examples, the handheld device is optionally placed within an enclosure that is worn on the head of the user. In some examples, the handheld device is optionally placed on a support (e.g., a tripod) in front of the user. In some examples, user-facing component 120 is an XR chamber, enclosure, or room configured to present XR content in which the user does not wear or hold user-facing component 120. Many user interfaces described with reference to one type of hardware for displaying XR content (e.g., a handheld device or a device on a tripod) could be implemented on another type of hardware for displaying XR content (e.g., a head-mounted device (HMD) or other wearable computing device). For example, a user interface showing interactions with XR content triggered based on interactions that happen in a space in front of a handheld or tripod-mounted device could similarly be implemented with an HMD where the interactions happen in a space in front of the HMD and the responses of the XR content are displayed via the HMD. Similarly, a user interface showing interactions with XR content triggered based on movement of a handheld or tripod-mounted device relative to the physical environment (e.g., scene 105 or a part of the user's body (e.g., the user's eye(s), head, or hand)) could similarly be implemented with an HMD where the movement is caused by movement of the HMD relative to the physical environment (e.g., scene 105 or a part of the user's body (e.g., the user's eye(s), head, or hand)).

FIG. 2 is a block diagram of user-facing component 120, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 2 is intended more as a functional description of the various features that could be present in a particular implementation, as opposed to a structural schematic of the examples described herein. As recognized by those of ordinary skill in the art, components shown separately could be combined and some components could be separated. For example, some functional modules shown separately in FIG. 2 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, user-facing component 120 (e.g., HMD) includes one or more processing units 202 (e.g., microprocessors, ASICs, FPGAs, GPUs, CPUs, processing cores, and/or the like), one or more input/output (I/O) devices and sensors 206, one or more communication interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 210, one or more XR displays 212, one or more optional interior- and/or exterior-facing image sensors 214, a memory 220, and one or more communication buses 204 for interconnecting these and various other components.

In some examples, one or more communication buses 204 include circuitry that interconnects and controls communications between system components. In some examples, one or more I/O devices and sensors 206 include at least one of an inertial measurement unit (IMU), an accelerometer, a gyroscope, a thermometer, one or more biometric sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some examples, one or more XR displays 212 are configured to provide an XR experience to the user. In some examples, one or more XR displays 212 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some examples, one or more XR displays 212 correspond to diffractive, reflective, polarized, holographic, etc. waveguide displays. For example, user-facing component 120 (e.g., HMD) includes a single XR display. In another example, user-facing component 120 includes an XR display for each eye of the user. In some examples, one or more XR displays 212 are capable of presenting XR content. In some examples, one or more XR displays 212 are omitted from user-facing component 120. For example, user-facing component 120 does not include any component that is configured to display content (or does not include any component that is configured to display XR content) and user-facing component 120 provides output via audio and/or haptic output types.

In some examples, one or more image sensors 214 are configured to obtain image data that corresponds to at least a portion of the face of the user that includes the eyes of the user (and may be referred to as an eye-tracking camera). In some examples, one or more image sensors 214 are configured to obtain image data that corresponds to at least a portion of the user's hand(s) and, optionally, arm(s) of the user (and may be referred to as a hand-tracking camera). In some examples, one or more image sensors 214 are configured to be forward-facing to obtain image data that corresponds to the scene as would be viewed by the user if user-facing component 120 (e.g., HMD) was not present (and may be referred to as a scene camera). One or more optional image sensors 214 can include one or more RGB cameras (e.g., with a complementary metal-oxide-semiconductor (CMOS) image sensor or a charge-coupled device (CCD) image sensor), one or more infrared (IR) cameras, one or more event-based cameras, and/or the like.

Memory 220 includes high-speed random-access memory, such as DRAM, SRAM, DDR RAM, or other random-access solid-state memory devices. In some examples, memory 220 includes non-volatile memory, such as one or more magnetic disk storage devices, optical disk storage devices, flash memory devices, or other non-volatile solid-state storage devices. Memory 220 optionally includes one or more storage devices remotely located from the one or more processing units 202. Memory 220 comprises a non-transitory computer-readable storage medium. In some examples, memory 220 or the non-transitory computer-readable storage medium of memory 220 stores the following programs, modules and data structures, or a subset thereof, including optional operating system 230 and XR experience module 240.

Operating system 230 includes instructions for handling various basic system services and for performing hardware dependent tasks. In some examples, XR experience module 240 is configured to present XR content to the user via one or more XR displays 212 or one or more speakers. To that end, in various examples, XR experience module 240 includes data obtaining unit 242, XR presenting unit 244, XR map generating unit 246, and data transmitting unit 248.

In some examples, data obtaining unit 242 is configured to obtain data (e.g., presentation data, interaction data, sensor data, location data, etc.) from at least controller 110 of FIG. 1. To that end, in various examples, data obtaining unit 242 includes instructions and/or logic therefor, and heuristics and metadata therefor.

In some examples, XR presenting unit 244 is configured to present XR content via one or more XR displays 212 or one or more speakers. To that end, in various examples, XR presenting unit 244 includes instructions and/or logic therefor, and heuristics and metadata therefor.

In some examples, XR map generating unit 246 is configured to generate an XR map (e.g., a 3D map of the extended reality scene or a map of the physical environment into which computer-generated objects can be placed) based on media content data. To that end, in various examples, XR map generating unit 246 includes instructions and/or logic therefor, and heuristics and metadata therefor.

In some examples, the data transmitting unit 248 is configured to transmit data (e.g., presentation data, location data, sensor data, etc.) to at least controller 110, and optionally one or more of input devices 125, output devices 155, sensors 190, and/or peripheral devices 195. To that end, in various examples, data transmitting unit 248 includes instructions and/or logic therefor, and heuristics and metadata therefor.

Although data obtaining unit 242, XR presenting unit 244, XR map generating unit 246, and data transmitting unit 248 are shown as residing on a single device (e.g., user-facing component 120 of FIG. 1), in other examples, any combination of data obtaining unit 242, XR presenting unit 244, XR map generating unit 246, and data transmitting unit 248 may reside on separate computing devices.

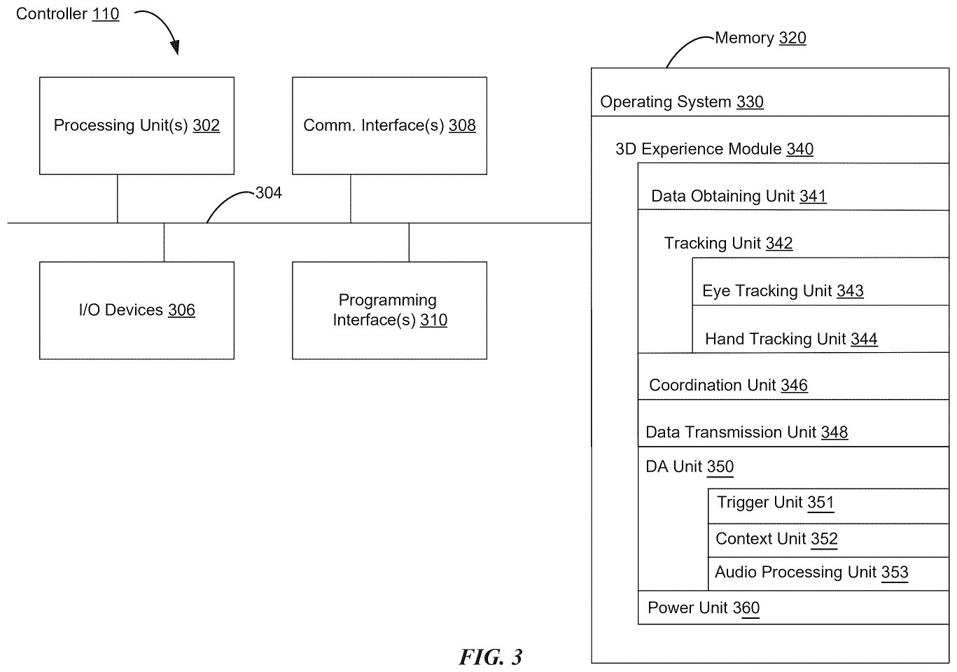

Returning to FIG. 1, controller 110 is configured to manage and coordinate a user's experience with respect to a three-dimensional scene. In some examples, controller 110 includes a suitable combination of software, firmware, and/or hardware. Controller 110 is described in greater detail below with respect to FIG. 3.

In some examples, controller 110 is a computing device that is local or remote relative to scene 105 (e.g., a physical environment). For example, controller 110 is a local server located within scene 105. In another example, controller 110 is a remote server located outside of scene 105 (e.g., a cloud server, central server, etc.). In some examples, controller 110 is communicatively coupled with the component(s) of computer system 101 that are configured to provide output to the user (e.g., output devices 155 and/or user-facing component 120) via one or more wired or wireless communication channels (e.g., BLUETOOTH, IEEE 802.11x, IEEE 802.16x, IEEE 802.3x, etc.). In some examples, controller 110 is included within the enclosure (e.g., a physical housing) of the component(s) of computer system 101 that are configured to provide output to the user (e.g., user-facing component 120) or shares the same physical enclosure or support structure with the component(s) of computer system 101 that are configured to provide output to the user.

In some examples, the various components and functions of controller 110 described below with respect to FIGS. 3, 4, 5A-5L, 6A-6G, 7, and 8 are distributed across multiple devices. For example, a first set of the components of controller 110 (and their associated functions) are implemented on a server system remote to scene 105 while a second set of the components of controller 110 (and their associated functions) are local to scene 105. For example, the second set of components are implemented within a portable electronic device (e.g., a wearable device such as an HMD) that is present within scene 105. It will be appreciated that the particular manner in which the various components and functions of controller 110 are distributed across various devices can vary based on different implementations of the examples described herein.

FIG. 3 is a block diagram of a controller 110, according to some examples. While certain specific features are illustrated, those skilled in the art will appreciate from the present disclosure that various other features have not been illustrated for the sake of brevity, and so as not to obscure more pertinent aspects of the examples disclosed herein. Moreover, FIG. 3 is intended more as a functional description of the various features that may be present in a particular implementation, as opposed to a structural schematic of the examples described herein. As recognized by those of ordinary skill in the art, components shown separately could be combined and some components could be separated. For example, some functional modules shown separately in FIG. 3 could be implemented in a single module and the various functions of single functional blocks could be implemented by one or more functional blocks in various examples. The actual number of modules and the division of particular functions and how features are allocated among them will vary from one implementation to another and, in some examples, depends in part on the particular combination of hardware, software, and/or firmware chosen for a particular implementation.

In some examples, controller 110 includes one or more processing units 302 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 306, one or more communication interfaces 308 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 310, memory 320, and one or more communication buses 304 for interconnecting these and various other components.

In some examples, one or more communication buses 304 include circuitry that interconnects and controls communications between system components. In some examples, one or more I/O devices 306 include at least one of a keyboard, a mouse, a touchpad, a joystick, one or more microphones, one or more speakers, one or more image sensors, one or more displays, and/or the like.

Memory 320 includes high-speed random-access memory, such as dynamic random-access memory (DRAM), static random-access memory (SRAM), double-data-rate random-access memory (DDR RAM), or other random-access solid-state memory devices. In some examples, memory 320 includes non-volatile memory, such as one or more magnetic disk storage devices, optical disk storage devices, flash memory devices, or other non-volatile solid-state storage devices. Memory 320 optionally includes one or more storage devices remotely located from the one or more processing units 302. Memory 320 comprises a non-transitory computer-readable storage medium. In some examples, memory 320 or the non-transitory computer-readable storage medium of memory 320 stores the following programs, modules and data structures, or a subset thereof, including an optional operating system 330 and three-dimensional (3D) experience module 340.

Operating system 330 includes instructions for handling various basic system services and for performing hardware-dependent tasks.

In some examples, three-dimensional (3D) experience module 340 is configured to manage and coordinate the user experience provided by computer system 101 with respect to a three-dimensional scene. For example, 3D experience module 340 is configured to obtain data corresponding to the three-dimensional scene (e.g., data generated by computer system 101 and/or data from data obtaining unit 341 discussed below) to cause computer system 101 to perform actions for the user (e.g., provide suggestions, display content, etc.) based on the data. To that end, in various examples, 3D experience module 340 includes data obtaining unit 341, tracking unit 342, coordination unit 346, data transmission unit 348, digital assistant (DA) unit 350, and 3D sound unit 360.

In some examples, data obtaining unit 341 is configured to obtain data (e.g., presentation data, interaction data, sensor data, location data, etc.) from one or more of user-facing component 120, input devices 125, output devices 155, sensors 190, and peripheral devices 195. To that end, in various examples, data obtaining unit 341 includes instructions and/or logic therefor, and heuristics and metadata therefor.

In some examples, tracking unit 342 is configured to map scene 105 and to track the position/location of the user (and/or of a portable device being held or worn by the user). To that end, in various examples, tracking unit 342 includes instructions and/or logic therefor, and heuristics and metadata therefor.

In some examples, tracking unit 342 includes eye tracking unit 343. Eye tracking unit 343 includes instructions and/or logic for tracking the position and movement of the user's gaze (or more broadly, the user's eyes, face, or head) using data obtained from eye tracking device 130. In some examples, eye tracking unit 343 tracks the position and movement of the user's gaze relative to a physical environment, relative to the user (e.g., the user's hand, face, or head), relative to a device worn or held by the user, and/or relative to content displayed by user-facing component 120.

Eye tracking device 130 is controlled by eye tracking unit 343 and includes various hardware and/or software components configured to perform eye tracking techniques. For example, eye tracking device 130 includes at least one eye tracking camera (e.g., infrared (IR) or near-IR (NIR) cameras) and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards mirrors that reflect IR or NIR light from the eyes to the eye tracking cameras. Eye tracking device 130 optionally captures images of the user's eyes (e.g., as a video stream captured at 60-120 frames per second), analyzes the images to generate eye tracking information, and communicates the eye tracking information to eye tracking unit 343. In some examples, two eyes of the user are separately tracked by respective eye tracking cameras and illumination sources. In some examples, only one eye of the user is tracked by a respective eye tracking camera and illumination sources.

In some examples, tracking unit 342 includes hand tracking unit 344. Hand tracking unit 344 includes instructions and/or logic for tracking, using hand tracking data obtained from hand tracking device 140, the position of one or more portions of the user's hands and/or motions of one or more portions of the user's hands. Hand tracking unit 344 tracks the position and/or motion relative to scene 105, relative to the user (e.g., the user's head, face, or eyes), relative to a device worn or held by the user, relative to content displayed by user-facing component 120, and/or relative to a coordinate system defined relative to the user's hand. In some examples, hand tracking unit 344 analyzes the hand tracking data to identify a hand gesture (e.g., a pointing gesture, a pinching gesture, a clenching gesture, and/or a grabbing gesture) and/or to identify content (e.g., physical content or virtual content) corresponding to the hand gesture, e.g., content selected by the hand gesture. In some examples, a hand gesture is an air gesture. An air gesture is a gesture that is detected without the user touching (or independently of) an input element that is part of a device (e.g., computer system 101, one or more input devices 125, hand tracking device 140, and/or device 500) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Hand tracking device 140 is controlled by hand tracking unit 344 and includes various hardware and/or software components configured to perform hand tracking and hand gesture recognition techniques. For example, hand tracking device 140 includes one or more image sensors (e.g., one or more IR cameras, 3D cameras, depth cameras, and/or color cameras, etc.) that capture three-dimensional information (e.g., a depth map) that represents a hand of a human user. The one or more image sensors capture the hand images with sufficient resolution to distinguish the fingers and their respective positions. In some examples, the one or more image sensors project a pattern of spots onto an environment that includes the hand and capture an image of the projected pattern. In some examples, the one or more image sensors capture a temporal sequence of the hand tracking data (e.g., captured three-dimensional information and/or captured images of the projected pattern) and hand tracking device 140 communicates the temporal sequence of the hand tracking data to hand tracking unit 344 for further analysis, e.g., to identify hand gestures, hand poses, and/or hand movements.

In some examples, hand tracking device 140 includes one or more hardware input devices configured to be worn and/or held by (or be otherwise attached to) one or more respective hands of the user. In such examples, hand tracking unit 344 tracks the position, pose, and/or motion of a user's hand based on tracking the position, pose, and/or motion of the respective hardware input device. Hand tracking unit 344 tracks the position, pose, and/or motion of the respective hardware input device optically (e.g., via one or more image sensors) and/or based on data obtained from sensor(s) (e.g., accelerometer(s), magnetometer(s), gyroscope(s), inertial measurement unit(s), and the like) contained within the hardware input device. In some examples, the hardware input device includes one or more physical controls (e.g., button(s), touch-sensitive surface(s), pressure-sensitive surface(s), knob(s), joystick(s), and the like). In some examples, instead of, or in addition to, performing a particular function in response to detecting a respective type of hand gesture, computer system 101 analogously performs the particular function in response to a user input that selects a respective physical control of the hardware input device. For example, computer system 101 interprets a pinching hand gesture input as a selection of an in-focus element and/or interprets selection of a physical button of the hardware device as a selection of the in-focus element.

In some examples, coordination unit 346 is configured to manage and coordinate the experience provided to the user via user-facing component 120, one or more output devices 155, and/or one or more peripheral devices 195. To that end, in various examples, coordination unit 346 includes instructions and/or logic therefor, and heuristics and metadata therefor.

In some examples, data transmission unit 348 is configured to transmit data (e.g., presentation data, location data, etc.) to user-facing component 120, one or more input devices 125, output devices 155, sensors 190, and/or peripheral devices 195. To that end, in various examples, data transmission unit 348 includes instructions and/or logic therefor, and heuristics and metadata therefor.

Digital assistant (DA) unit 350 includes instructions and/or logic for providing DA functionality to computer system 101. DA unit 350 therefore provides a user of computer system 101 with DA functionality while they and/or their avatar are present in a three-dimensional scene. For example, the DA performs various tasks related to the three-dimensional scene based on a determined user intent. In some examples, the DA determines and acts on user intents either proactively or upon explicit request from the user. Accordingly, in some examples, DA unit 350 includes trigger unit 351, which defines active “triggers” (e.g., conditions) that, when detected (e.g., using data obtained from data obtaining unit 341), enable and/or cause DA unit 350 to determine and act on a user intent. For example, trigger unit 351 defines a verbal trigger (e.g., a spoken word or phrase) such as “Assistant,” “Hey Assistant,” and/or “Hey,” which the user can speak out loud to begin receiving assistance from DA unit 350.

DA unit 350 is configured to determine a user intent based on a set of current context information (e.g., information describing the current 3D scene (e.g., the physical or extended reality environment) and/or a current state of computer system 101). For example, the set of current context information includes inferences about the 3D scene, such as the user's location, surroundings, current activities, and/or predicted activities. DA unit 350 includes context unit 352, which compiles and analyzes data from data obtaining unit 341 (e.g., detected information, such as presentation data, interaction data, sensor data, and/or location data) and/or operating system 330 (e.g., device data, application data, and/or user data) to determine and/or update the set of current context information. For example, context unit 352 uses location data, motion sensor data, biometric sensor data, and data from the user's calendar application, to determine that the user has started biking to a restaurant for a friend's birthday dinner, from which DA unit 350 infers a user intent to provide audio biking instructions to the restaurant.

In some examples, DA unit 350 is configured to determine a user intent based on audio data (e.g., data detected using one or more audio sensors, such as microphones and/or vibration sensors). Accordingly, DA unit 350 includes audio processing unit 353, which processes audio data from data obtaining unit 341 to determine features and content included in detected audio. For example, audio processing unit 353 includes systems for performing audio recognition, such as speech-to-text (STT) and natural-language processing (NLP) techniques for interpreting spoken user inputs (e.g., determining a user intent from a spoken request). In some examples, trigger unit 351 uses audio processing unit 353 to detect audio triggers, such as spoken user requests directed to the DA. In some examples, context unit 352 uses audio processing unit 353 to identify current context information from detected audio data, such as determining whether a user is outside or inside a building based on ambient noise. For example, audio processing unit 353 is configured to perform lower-power audio processing to detect audio triggers (e.g., using cross-correlation to match audio patterns) and/or to perform higher-power audio processing to identify and interpret a wider range of sounds and speech.

Power unit 360 instructions and/or logic for managing power usage by the various components of 3D experience module 340 based on a power state of computer system 101. In some examples, based on system status (e.g., remaining battery life, battery charge state, and/or electronic device specifications) and/or power settings (e.g., running computer system 101 in a low-power (e.g., battery saving) mode, a standard mode, and/or a high-performance mode), power unit 360 configures how and when data obtaining unit 341 obtains data, context unit 352 determines (e.g., updates) the set of current contextual information, audio processing unit 353 processes audio, and/or trigger unit 351 triggers DA unit 350 to determine and act on a user intent in order to implement the functionality of DA unit 350 in a power-efficient manner.

In some examples, power unit 360 manages power usage by limiting (e.g., gating) which of the sensors 3D experience module 340 are active (e.g., powered on) and used to collect data (e.g., by data obtaining unit 341). For example, certain sensor data, such as image data captured using one or more cameras, location data detected using a GPS system, and/or higher-resolution data, may be more power-intensive to capture than other sensor data, such as audio data captured using one or more audio sensor devices (e.g., microphones and/or bone vibration sensors), motion data captured using one or more accelerometers, and/or lower-resolution data. Accordingly, in some examples, power unit 360 controls which sensors are used and/or how often they are used (e.g., a data capture rate, such as a frame rate or sample rate) to achieve appropriate power usage.

In some examples, power unit 360 manages power usage by limiting (e.g., gating) which of the data collected by data obtaining unit 341 is processed and/or analyzed by DA unit 350 (e.g., using context unit 352, audio processing unit 353, and/or other data analysis systems and techniques). For example, performing image processing on camera data to identify visual features and/or processing motion data to identify user movements may be more power-intensive than performing audio processing on audio data to identify audio characteristics and/or processing location data to determine the user's location. As another example, certain audio processing techniques, such as STT and NLP, may be more power-intensive than other audio processing techniques, such as cross-correlation for matching detected audio to reference audio. As another example, certain image processing techniques, such as machine vision techniques implementing neural network and/or transformer models, may be more power-intensive than other image processing techniques, such as optical character recognition (OCR), edge detection, and/or other algorithmic image processing models. Accordingly, in some examples, power unit 360 controls which data are processed and which processes are used to achieve appropriate power usage.

In some examples, 3D experience module 340 accesses one or more artificial intelligence (AI) models that are configured to perform various functions described herein. The AI model(s) are at least partially implemented on controller 110 (e.g., implemented locally on a single device, or implemented in a distributed manner) and/or controller 110 communicates with one or more external services that provide access to the AI model(s). In some examples, one or more components and functions of DA unit 350, such as trigger unit 351, context unit 352, and/or audio processing unit 353, are implemented using the AI model(s). For example, DA unit 350 implements one or more AI models to perform audio recognition, object recognition (e.g., image and/or video processing), contextual analysis, natural language processing, and/or intent determination.

In some examples, the AI model(s) are based on (e.g., are, or are constructed from) one or more foundation models. Generally, a foundation model is a deep learning neural network that is trained based on a large training dataset and that can adapt to perform a specific function. Accordingly, a foundation model aggregates information learned from a large (and optionally, multimodal) dataset and can adapt to (e.g., be fine-tuned to) perform various downstream tasks that the foundation model may not have been originally designed to perform. Examples of such tasks include language translation, speech recognition, user intent determination, sentiment analysis, computer vision tasks (e.g., object recognition and scene understanding), context analysis tasks, question answering, image generation, audio generation, and generation of computer-executable instructions. Foundation models can accept a single type of input (e.g., text data) or accept multimodal input, such as two or more of text data, image data, video data, audio data, sensor data, and the like. In some examples, a foundation model is prompted to perform a particular task by providing it with a natural language description of the task. Example foundation models include the GPT-n series of models (e.g., GPT-1, GPT-2, GPT-3, and GPT-4), DALL-E, and CLIP from Open AI, Inc., Florence and Florence-2 from Microsoft Corporation, BERT from Google LLC, and LLAMA, LLAMA-2, and LLAMA-3 from Meta Platforms, Inc.

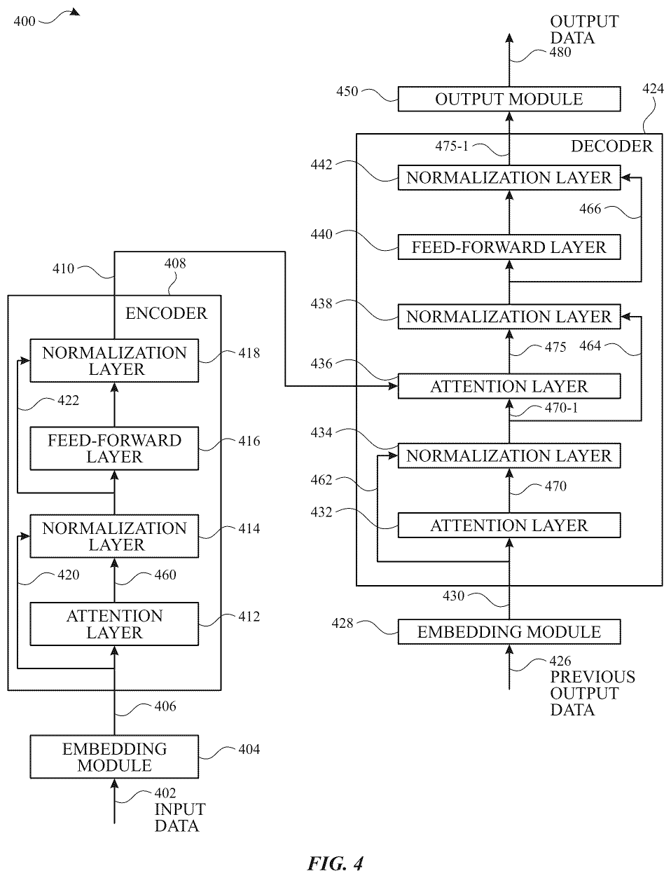

FIG. 4 illustrates architecture 400 for a foundation model, according to some examples. Architecture 400 is merely exemplary and various modifications to architecture 400 are possible. Accordingly, the components of architecture 400 (and their associated functions) can be combined, the order of the components (and their associated functions) can be changed, components of architecture 400 can be removed, and other components can be added to architecture 400. Further, while architecture 400 is transformer-based, one of skill in the art will understand that architecture 400 can additionally or alternatively implement other types of machine learning models, such as convolutional neural network (CNN)-based models and recurrent neural network (RNN)-based models.

Architecture 400 is configured to process input data 402 to generate output data 480 that corresponds to a desired task. Input data 402 includes one or more types of data, e.g., text data, image data, video data, audio data, sensor (e.g., motion sensor, biometric sensor, temperature sensor, and the like) data, computer-executable instructions, structured data (e.g., in the form of an XML file, a JSON file, or another file type), and the like. In some examples, input data 402 includes data from data obtaining unit 341. Output data 480 includes one or more types of data that depend on the task to be performed. For example, output data 480 includes one or more of: text data, image data, audio data, and computer-executable instructions. It will be appreciated that the above-described input and output data types are merely exemplary and that architecture 400 can be configured to accept various types of data as input and generate various types of data as output. Such data types can vary based on the particular function the foundation model is configured to perform.

Architecture 400 includes embedding module 404, encoder 408, embedding module 428, decoder 424, and output module 450, the functions of which are now discussed below.

Embedding module 404 is configured to accept input data 402 and parse input data 402 into one or more token sequences. Embedding module 404 is further configured to determine an embedding (e.g., a vector representation) of each token that represents each token in embedding space, e.g., so that similar tokens have a closer distance in embedding space and dissimilar tokens have a further distance. In some examples, embedding module 404 includes a positional encoder configured to encode positional information into the embeddings. The respective positional information for an embedding indicates the embedding's relative position in the sequence. Embedding module 404 is configured to output embedding data 406 of the input data by aggregating the embeddings for the tokens of input data 402.

Encoder 408 is configured to map embedding data 406 into encoder representation 410. Encoder representation 410 represents contextual information for each token that indicates learned information about how each token relates to (e.g., attends to) each other token. Encoder 408 includes attention layer 412, feed-forward layer 416, normalization layers 414 and 418, and residual connections 420 and 422. In some examples, attention layer 412 applies a self-attention mechanism on embedding data 406 to calculate an attention representation (e.g., in the form of a matrix) of the relationship of each token to each other token in the sequence. In some examples, attention layer 412 is multi-headed to calculate multiple different attention representations of the relationship of each token to each other token, where each different representation indicates a different learned property of the token sequence. Attention layer 412 is configured to aggregate the attention representations to output attention data 460 indicating the cross-relationships between the tokens from input data 402. In some examples, attention layer 412 further masks attention data 460 to suppress data representing the relationships between select tokens. Encoder 408 then passes (optionally masked) attention data 460 through normalization layer 414, feed-forward layer 416, and normalization layer 418 to generate encoder representation 410. Residual connections 420 and 422 can help stabilize and shorten the training and/or inference process by respectively allowing the output of embedding module 404 (i.e., embedding data 406) to directly pass to normalization layer 414 and allowing the output of normalization layer 414 to directly pass to normalization layer 418.

While FIG. 4 illustrates that architecture 400 includes a single encoder 408, in other examples, architecture 400 includes multiple stacked encoders configured to output encoder representation 410. Each of the stacked encoders can generate different attention data, which may allow architecture 400 to learn different types of cross-relationships between the tokens and generate output data 410 based on a more complete set of learned relationships.

Decoder 424 is configured to accept encoder representation 410 and previous output embedding 430 as input to generate output data 480. Embedding module 428 is configured to generate previous output embedding 430. Embedding module 428 is similar to embedding module 404. Specifically, embedding module 428 tokenizes previous output data 426 (e.g., output data 480 that was generated by the previous iteration), determines embeddings for each token, and optionally encodes positional information into each embedding to generate previous output embedding 430.

Decoder 424 includes attention layers 432 and 436, normalization layers 434, 438, and 442, feed-forward layer 440, and residual connections 462, 464, and 466. Attention layer 432 is configured to output attention data 470 indicating the cross-relationships between the tokens from previous output data 426. Attention layer 432 is similar to attention layer 412. For example, attention layer 432 applies a multi-headed self-attention mechanism on previous output embedding 430 and optionally masks attention data 470 to suppress data representing the relationships between select tokens (e.g., the relationship(s) between a token and future token(s)) so architecture 400 does not consider future tokens as context when generating output data 480. Decoder 424 then passes (optionally masked) attention data 470 through normalization layer 434 to generate normalized attention data 470-1.

Attention layer 436 accepts encoder representation 410 and normalized attention data 470-1 as input to generate encoder-decoder attention data 475. Encoder-decoder attention data 475 correlates input data 402 to previous output data 426 by representing the relationship between the output of encoder 408 and the previous output of decoder 424. Attention layer 436 allows decoder 424 to increase the weight of the portions of encoder representation 410 that are learned as more relevant to generating output data 480. In some examples, attention layer 436 applies a multi-headed attention mechanism to encoder representation 410 and to normalized attention data 470-1 to generate encoder-decoder attention data 475. In some examples, attention layer 436 further masks encoder-decoder attention data 475 to suppress the cross-relationships between select tokens.

Decoder 424 then passes (optionally masked) encoder-decoder attention data 475 through normalization layer 438, feed-forward layer 440, and normalization layer 442 to generate further-processed encoder-decoder attention data 475-1. Normalization layer 442 then provides further-processed encoder-decoder attention data 475-1 to output module 450. Similar to residual connections 420 and 422, residual connections 462, 464, and 466 may stabilize and shorten the training and/or inference process by allowing the output of a corresponding component to directly pass as input to a corresponding component.

While FIG. 4 illustrates that architecture 400 includes a single decoder 424, in other examples, architecture 400 includes multiple stacked decoders each configured to learn/generate different types of encoder-decoder attention data 475. This allows architecture 400 to learn different types of cross-relationships between the tokens from input data 402 and the tokens from output data 480, which may allow architecture 400 to generate output data 480 based on a more complete set of learned relationships.

Output module 450 is configured to generate output data 480 from further-processed encoder-decoder attention data 475-1. For example, output module 450 includes one or more linear layers that apply a learned linear transformation to further-processed encoder-decoder attention data 475-1 and a softmax layer that generates a probability distribution over the possible classes (e.g., words or symbols) of the output tokens based on the linear transformation data. Output module 450 then selects (e.g., predicts) an element of output data 480 based on the probability distribution. Architecture 400 then passes output data 480 as previous input data 426 to embedding module 428 to begin another iteration of the training and/or inference process for architecture 400.

It will be appreciated that various different AI models can be constructed based on the components of architecture 400. For example, some large language models (LLMs) (e.g., GPT-2 and GPT-3) are decoder-only (e.g., include one or more instances of decoder 424 and do not include encoder 408), some LLMs (e.g., BERT) are encoder-only (include one or more instances of encoder 408 and do not include decoder 424), and other foundation models (e.g., Florence-2) are encoder-decoder (e.g., include one or more instances of encoder 408 and include one or more instances of decoder 424). Further, it will be appreciated that the foundation models constructed based on the components of architecture 400 can be fine-tuned based on reinforcement learning techniques and training data specific to a particular task for optimization for the particular task, e.g., extracting relevant semantic information from image and/or video data, generating code, generating music, providing suggestions relevant to a specific user, and the like.

FIGS. 5A-51 illustrate action assistance using a digital assistant, including action assistance using nonverbal audio detection and low-power action assistance, according to some examples. The left panels of FIGS. 5A-51 represent portions of scene data for a three-dimensional scene that are obtained and/or processed by device 500 (e.g., using data obtaining unit 341, context unit 352, and/or audio processing unit 352), such as inputs, detected sensor data, and/or other obtained information describing the current 3D scene (e.g., the physical or extended reality environment, such as audio data detected using one or more microphones, image data detected using one or more cameras, other sensor data) and/or a current state of computer system 101. The right panels represent respective actions performed by device 500 (e.g., using DA unit 350) based on the obtained and processed data (e.g., the set of current contextual information). For illustrative purposes, the respective actions are visually represented using various outputs, such as visual content, audio content, and/or tactile content (e.g., vibrations and/or other haptic outputs). In some examples, the various outputs are actually provided, for instance, displaying the visual content via one or more display generation components of device 500, outputting the audio content via one or more audio output device (e.g., speakers) of device 500, and/or outputting the tactile content via one or more tactile output devices of device 500. However, in some examples, device 500 performs one or more of the respective actions without actually providing one or more of the output, for example, performing an action as a background process without automatically outputting associated content.

Device 500 implements at least some of the components of computer system 101. For example, device 500 includes one or more sensors configured to detect scene data (e.g., audio data, image data, movement data, location data, biometric data, and/or other data corresponding to the 3D scene). In some examples, device 500 is an HMD (e.g., an XR headset or smart glasses). In other examples, device 500 is another type of device, such as a smart watch, a smart phone, a tablet device, a laptop computer, or a projection-based device.

The examples of FIGS. 5A-51 illustrate that the user and device 500 are present within the respective scenes. For example, the scenes are physical or extended reality scenes and the user and device 500 are physically present within the scenes. In other examples, an avatar of the user is present within the scenes. For example, when the scenes are virtual reality scenes, the avatar of the user is present within the virtual reality scenes.

In FIG. 5A, a DA of device 500 (e.g., DA unit 350) determines the context of the scene by obtaining and analyzing scene data 502 (e.g., using context unit 352) to make contextual inferences about the 3D scene (e.g., the user's location, surroundings, current activities, and/or predicted activities). In particular, the DA obtains location data and determines, based on the location data, that the user and device 500 have recently arrived at the user's gym, and thus that the current context has changed to a gym context. In some examples, the DA determines the context using additional data, such as device information indicating that the user has scanned a digital gym membership card configured on device 500 (e.g., confirming that the user has entered the gym), and/or determines additional context, such as analyzing usage history information to determine that the user typically engages in weightlifting, running, and basketball workouts at the gym.

In some examples, at FIG. 5A, device 500 is operating in a power saving (e.g., low-power) mode. In some examples, in the power saving mode, the DA only obtains and/or analyzes certain types of scene data to determine the current context at FIG. 5A. For example, although device 500 includes one or more cameras, the cameras are placed (e.g., by power unit 360) in an inactive state (e.g., not capturing data) and/or a low-power state (e.g., capturing data at a low rate and/or with a low resolution) at FIG. 5A. As another example, the DA refrains from analyzing (e.g., using image processing and/or machine vision techniques) camera data detected using the one or more cameras at FIG. 5A. Instead, the DA relies on obtaining and analyzing the other scene data and information (e.g., location data, motion data, audio data, device information, usage history information, and/or other sensor and device data) to determine the current context, which reduces power usage by device 500 and helps to preserve user privacy (e.g., limiting the gathering of data about the user's visible surroundings).

Based on the determined context of the gym, the DA selects a set of audio triggers 504 for action assistance. As illustrated in the right panel of FIG. 5A, the set of audio triggers include selected nonverbal triggers: environmental and/or user-produced sounds (e.g., types of sounds) other than articulated speech that the DA can distinctly recognize (e.g., using audio processing unit 353). The nonverbal triggers include a sharp exhale, footfall on a treadmill, footfall on a basketball court, and mechanical movement of a weight machine (e.g., environmental and/or user-produced sounds associated with the context of the gym). Additionally, the set of audio triggers include selected verbal triggers (e.g., spoken words and phrases), such as “Assistant,” “Hey Assistant,” “workout,” and/or other words and phrases associated with the context of the gym.

At FIG. 5B, device 500 detects audio data 506 including a sharp exhale. For example, the DA processes detected audio data (e.g., using audio processing unit 353) to determine whether the characteristics of the detected audio data 506 match the characteristics of any of selected audio triggers 504. For example, the DA performs a cross-correlation between the detected audio data and reference data characterizing the audio features (e.g., frequency content, amplitude, and/or patterns) of the active nonverbal triggers, and, based on the cross-correlation with portion of audio data 506A indicating a match with the audio characteristics of a sharp exhale, the DA determines that device 500 has “heard” a sharp exhale.

Because a sharp exhale is included in the set of nonverbal triggers selected based on the context of the current scene (e.g., the user being at the gym), at FIGS. 5B-5C, the DA performs one or more actions in response to detecting the sharp exhale. In particular, as illustrated in the right panel of FIG. 5B, the DA initiates a workout rep counter, for instance, using a fitness application. For example, based on the current context of the user being at the gym (e.g., and the user's history of weightlifting workouts) and the identification of the sharp exhale, the DA infers that the user has likely completed a weightlifting rep (e.g., breathing out during exertion) and determines a corresponding user intent to count (e.g., track) reps and sets for a weightlifting workout. The DA thus proactively acts on the determined user intent, counting weightlifting reps for the user without the user needing to explicitly request assistance and/or manually initiate a workout in the fitness application. In some examples, the DA provides an output indicating a result of the action, such as displaying user interface 508A, a user interface of the fitness application for the workout rep counter, on a display of device 500 and/or providing a tactile (e.g., haptic) output 508B to indicate that a workout has been started in the fitness application.

In some examples, providing the workout rep counter includes obtaining and analyzing additional scene data, such as motion sensor data and/or biometric data, in order to count the weightlifting reps (e.g., incrementing the rep counter based on the user's movements) and track the user's biometrics (e.g., heart rate) for the detected workout. In some examples, device 500 continues to “listen” for additional sharp exhales and/or “look” at the camera data, motion data, and/or biometric data to detect additional reps and increment the rep counter.

In response to detecting the sharp exhale, at FIG. 5C, the DA additionally performs the action of obtaining and analyzing additional scene data to confirm, refine, or correct the understanding of the scene established in FIGS. 5A-5B, for instance, determining (e.g., updating) the current context and/or performing follow-up actions. In particular, using the one or more cameras, device 500 captures image data 510 as illustrated in the left panel of FIG. 5C, which the DA analyzes (e.g., using image processing and/or machine vision techniques) to identify that the user is performing a squat exercise using 85 pounds of weight (e.g., a 45-pound bar and four 10-pound plates), thus determining the context of what the user is doing at the gym with more specificity. At FIG. 5C, based on the updated context provided by the image data, the DA infers a user intent to track the specific squat workout, and thus modifies one or more parameters of the initiated action, adjusting the workout rep timer to specifically track squat reps and to note the weight being used as illustrated in the right panel of FIG. 5C. In contrast, if the image data instead showed the user spotting a friend doing a squat exercise, the DA would cancel the initiated workout rep counter without logging a squat workout in the fitness application for the user.

In some examples, instead of or in addition to using the camera data to refine the context, the DA obtains and analyzes motion data and/or biometric data to identify that the user is (or is not) performing a squat exercise. In some examples, the DA only temporarily obtains and analyzes the additional context information (e.g., camera data, motion data, and/or biometric data) following the detection of the sharp exhale, using the additional context information to check the nonverbal trigger without continuing to gather and analyze additional data. In some examples, in response to detecting the sharp exhale, device 500 begins operating in a higher-power mode, collecting and analyzing the additional context information (e.g., camera data, motion data, and/or biometric data) with increased frequency and detail.

In response to detecting the sharp exhale and/or based on image data 510 (e.g., the updated context information identifying the specific exercise the user is doing at the gym), the DA additionally updates selected set of audio triggers 504. For example, the DA selects the sound of re-racking a barbell to add to the set of active nonverbal triggers and additionally selects verbal audio triggers (e.g., words or phrases) to include in the selected set of active audio triggers, such as “reps,” “sets,” “squats,” and/or other words or phrases related to the current context.

At FIG. 5D, device 500 detects audio data 512, including the sound of re-racking a barbell, which is a currently-active nonverbal trigger, detected in portion of audio data 512A. In response to detecting the sound of re-racking the barbell, the DA performs the action of logging a completed set in the workout rep counter (e.g., incrementing a “set” count and resetting the rep counter for the next set), as illustrated in the right panel of FIG. 5D. For example, based on the current context of the user being at the gym and engaging in a squat exercise, the previous detection of the sharp exhale, and the detection of the sound of re-racking the barbell, the DA infers that the user has likely completed a squat set (e.g., setting the bar back on a squat rack to rest between sets) and determines a corresponding user intent to count (e.g., track) the current set of reps as completed. As illustrated in FIG. 5D, in some examples, device 500 outputs a digital assistant output in response to the sound of re-racking the barbell, such as playing audio output 514A, a chime indicating completion of a set in the fitness application, and/or providing spoken output 514B, “First set complete” (e.g., a synthesized speech output provided by the DA), using one or more audio output devices (e.g., speakers or headphones).

In some examples, device 500 performs the action of logging the completed set solely in response to detecting the sound of re-racking a barbell, for instance, without obtaining and/or using camera data, motion data, and/or biometric data. Accordingly, in some examples, device 500 continues to operate in the power saving mode at FIG. 5D. In some examples, in response to detecting the sound of re-racking the barbell, the DA obtains and analyzes additional context information to confirm the action of logging the completed set, for instance, “checking” the nonverbal trigger using camera data, motion data, and/or biometric data, as described with respect to FIG. 5C.

At FIG. 5E, device 500 detects audio data 516 including a natural-language speech input, “How many reps was that?,” which includes the active verbal trigger “reps” in portion of audio data 516A. In response to detecting the active verbal trigger, at FIG. 5E, the DA performs the action of initiating a digital assistant session to respond to the speech input. In particular, the DA performs additional audio analysis (e.g., using STT and NLP techniques) on audio data 516 identify the speech input (e.g., in portion 516B) and determine a user intent to obtain information about the current workout. In particular, the detected speech is processed using the context information determined from and in response to the detection of the nonverbal triggers, for instance, interpreting (e.g., disambiguating) the user request “how many was that?” as “how many squats have I done?”

At FIG. 5E, in response to the natural-language speech input, the DA determines a user intent to obtain information about the current workout context, and accordingly, provides speech output 518A, “You have completed one set of six squats” (e.g., a digital assistant output provided using synthesized speech). In some examples, initiating the digital assistant session includes displaying digital assistant indicator 518B via a display of device 500 to indicate to the user that a digital assistant session is active. While the digital assistant session is active, the DA continues performing additional audio analysis on detected audio data to “listen” for and respond to further speech inputs from the user without the user needing to provide additional trigger inputs, such as saying “Hey Assistant” (e.g., as further described with respect to FIG. 5H). In some examples, the DA automatically ends the digital assistant session after a period of time elapses without detecting additional speech inputs. However, even after ending the digital assistant session, the DA continues to “listen” for the active audio triggers, for instance, incrementing the rep counter in response to detecting additional exhales and incrementing the set counter in response to detecting the barbell being re-racked.

At FIG. 5F, the DA determines that the current context has changed. For example, the DA (e.g., context unit 352) periodically reviews previously-determined context information and newly-obtained context information (e.g., including data obtained by data obtaining unit 341 and analyzed by DA unit 350) to identify whether contextual inferences about the 3D scene (e.g., the user's location, surroundings, current activities, and/or predicted activities) are still supported. In particular, as illustrated in FIG. 5F, the DA uses the one or more cameras to capture image data 520 and determines, based on image data 520 (e.g., showing the user's refrigerator and stove) and/or other scene data (e.g., contextual information indicating that the user is physically at home, that the device is near a smart speaker device assigned to the user's kitchen, that the user typically cooks dinner around the current time of day, that the user has recently accessed a recipe for tacos on the device, and so forth), that the user and device 500 are no longer at the gym and are instead at the user's home, and specifically, in the user's kitchen.

In some examples, while device 500 is operating in a power-saving mode, the DA determines (e.g., checks) whether the current context has changed at a particular frequency (e.g., once every 10 seconds) and/or using particular data (e.g., only updating the current context using the cameras at a low frequency and/or not using camera data to update the current context). For example, at FIG. 5F, device 500 captures image data and/or performs image analysis to update the current context only once every ten seconds, thirty seconds, one minute, or five minutes. In some examples, device 500 updates the current context using a particular camera, such as a lower-resolution camera, and/or using a lower-power image analysis technique, for instance, performing coarse object recognition on the captured image data to determine that the visual context indicates that the user is in their kitchen, without performing additional analysis to identify specific objects.

In response to determining that the current context has changed, at FIG. 5F, the DA updates set of audio triggers 504, selecting the new nonverbal triggers of opening and closing an oven door, lighting a burner of a gas stove, sizzling food, a kitchen timer alarm, and a smoke alarm and the new verbal triggers “cooking,” “timer,” and “recipe.” As the current context no longer indicates that the user is at the gym, the updated set of audio triggers 504 removes audio triggers associated with the gym context that were included in previously-selected audio triggers 504 (e.g., the DA deactivates the nonverbal triggers including the sharp exhale, footfall on a treadmill, footfall on a basketball court, mechanical movement of a weight machine, closing a locker door, and re-racking a barbell and the verbal triggers “workout,” “rep,” and “set”).

At FIG. 5G, device 500 detects audio data 524, which includes both a sharp exhale (524B) and the sound of lighting a burner of a gas stove (524A). Because the sound of lighting the range is included in the selected set of audio triggers 504, the DA determines a user intent to cook food in the kitchen. Accordingly, the DA performs the action of initiating a digital assistant session (e.g., displaying digital assistant indicator 518B) in response to portion of audio data 524A to allow the user to interact with device 500 using natural-language speech inputs (e.g., hands-free) without needing to provide an additional trigger input. In contrast, at FIG. 5G, the DA does not perform the action of initiating a workout rep counter in response to portion of audio data 524B, as the sharp exhale is not included in the updated set of audio triggers 504.

In some examples, in response to detecting the sound of lighting the burner of the gas stove, device 500 begins operating in a higher-power mode (e.g., a standard or high-performance power mode, as described with respect to power unit 360). For example, while the digital assistant session is active, the DA obtains and analyzes image data (e.g., image data 532B, as described below) and/or other types of sensor data with greater frequency. For example, in the higher-power mode, device 500 uses the one or more cameras to capture image data at a higher frequency (e.g., once every five seconds, once per second, twice per second) and/or to capture image data at a video frame rate (e.g., capturing a video stream at 24 FPS, 60 FPS, 120 FPS, etc.). In some examples, in the higher-power mode, the DA updates the current context information more frequently.

At FIG. 5H, device 500 detects audio data 528 including the sound of sizzling food. In response to detecting the sound of sizzling food, the DA infers that ingredients were added to a pan on the stove and determines a user intent to keep track of a cooking task. Accordingly, the DA performs the action of initiating a cooking timer 530A, which tracks the amount of time elapsed since the user started cooking the ingredients. In some examples, device 530 displays a timer user interface for 530A. Additionally, the DA provides spoken output 530B, “I'll keep an eye on that,” indicating to the user that the DA started cooking timer 530A for the ingredients the user added to the pan.

In some examples, the DA starts cooking timer 530A without obtaining and/or analyzing image data using the one or more cameras, instead basing the response solely on the previously-determined context of the kitchen, the detection of the sound of lighting the range of the gas stove, and the detection of the sound of sizzling food. In other examples, the DA uses image data (e.g., image data 532B, as described below) to confirm and/or refine performance of starting cooking timer 530A, such as image data captured during the digital assistant session (e.g., while operating in the higher-power mode) and/or captured in response to detecting the sound of sizzling food (e.g., as described with respect to capturing image data 510 in response to detecting the sharp exhale, as described with respect to FIGS. 5B-5C, above).

At FIG. 5I, device 500 detects audio data 532A, including a speech input, “What's the next recipe step?” In response to detecting the speech input, because a digital assistant session was initiated in response to detecting the sound of lighting the burner of the gas stove, the DA performs additional audio analysis (e.g., performing STT and NLP techniques) on audio data 532A and determines a user intent to get help from the DA with cooking a meal. Accordingly, at FIG. 5I, the DA uses the one or more cameras to capture image data 532B and analyzes image data 532B to identify that a sliced onion is cooking in a pan on the stove and to extract text from a recipe card in the scene. In some examples, the DA uses a higher-resolution camera to capture the additional image data 532B and/or analyzes image data 532B using different processes than were used when analyzing image data 520 (e.g., prior to detecting trigger and/or initiating the digital assistant session) to update the current context.

Alternatively (e.g., if a digital assistant session had not been initiated and/or the digital assistant session ended prior to detecting audio data 532A), the DA uses the one or more cameras to capture image data 532B in response to detecting the active audio trigger “recipe” in audio data 532A.

At FIG. 5I, based on audio data 532A, image data 532B, and cooking timer 530A, the DA provides spoken output 534, “Cook the onions for 22 more minutes, stirring occasionally, until golden.” Additionally, the DA updates cooking timer 530A, annotating it with a label (e.g., metadata) indicating that the timer is measuring the onion cook time. For example, the metadata allows the DA to track the visual information associated with cooking timer 530A, even if device 500 stops collecting image data and/or the pan leaves the field-of-view of the cameras.

In some examples, in addition to providing spoken output 534, the DA updates the current context information based on the previously-detected and analyzed scene data to indicate that the user is making a recipe for tacos (e.g., based on the image data of the recipe card) and that the user is currently caramelizing the onions (e.g., based on the detected stove noises and the image data of the onions in the pan). Based on the updated context information, the DA also updates the selected set of audio triggers to include the verbal audio triggers “onion” and “taco” and to remove the nonverbal audio trigger of opening and closing the oven door (e.g., as the recipe does not involve the use of an oven). Accordingly, the DA maintains up-to-date context information and audio triggers, allowing the DA to continue providing contextually-relevant assistance. For example, device 500 and the DA can provide the user with reminders to stir the onions based on cooking timer 530A and the associated metadata (e.g., identifying the onions), start additional cooking timers in response to detecting additional burners of the gas stove being lit based on detected audio and/or image data, and, even if the digital assistant session ends after a period without further verbal user inputs, respond to additional spoken user inputs related to making the tacos (e.g., based on detecting the currently-active verbal triggers).

Additional descriptions regarding FIGS. 5A-5I are provided below in reference to methods 600 and 700, described below with respect to FIGS. 6-7.

FIG. 6 is a flow diagram of a method 600 for providing action assistance using nonverbal audio detection, according to some examples. In some examples, method 700 is performed at a computer system (e.g., computer system 101 in FIG. 1, device 500) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors). In some examples, method 600 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 600 are distributed across multiple computer systems, e.g., a computer system and a separate server system. Some operations in method 600 are, optionally, combined, the orders of some operations are, optionally, changed, and some operations are, optionally, omitted.

At block 602, one or more nonverbal audio events are selected (e.g., by trigger unit 351) based on a first set of contextual information (e.g., current contextual information, e.g., provided by context unit 352). For example, the first set of contextual information includes and/or is based on data from data obtaining unit 341 (e.g., 502, 506, 510, 512, 516, 520, 524, 528, 532A, and/or 532B), from the computer system (e.g., operating system, application, and/or digital assistant data), and/or from data processing (e.g., from context unit 352 and/or audio processing unit 353).

For example, the nonverbal triggers are selected from a set of environmental and/or user-produced sounds and types of sounds that can be distinctly identified from detected audio data and do not include words or phrases (e.g., do not include articulated speech). For example, as described with respect to FIGS. 5A, based on a first set of contextual information indicating that the user is working out at the gym (e.g., contextual information indicating that the user is physically at the gym, that the user typically works out around the current time of day, that the user has scanned a gym access card, that the user has put on wireless headphones and started a workout playlist, and so forth), nonverbal audio events such as the sounds of a sharp exhale, footfall on a treadmill, footfall on a basketball court, mechanical movement of a weight machine, and re-racking a barbell are selected. For example, the nonverbal audio events may include sounds and types of sounds such as non-verbal vocalizations (e.g., coughs, sighs, hums, inhales, exhales, tongue clicks), alarms, sirens, mechanical noises (e.g., sounds made by doors, locks, vehicles, appliances, furniture, and/or personal effects), animal noises, footsteps, weather conditions (e.g., rain, thunder, hail, and/or wind), and/or any other sounds that can be detected, characterized, and recognized based on their audio characteristics.

At block 604, an active set of nonverbal audio events (e.g., 504) is populated (e.g., by trigger unit 351) with the one or more nonverbal audio events selected based on the first set of contextual information. For example, as described with respect to FIGS. 5A, 5C, 5G, and 5I, any of the selected nonverbal audio events that were not previously included in the active set of nonverbal audio events are added (e.g., activated), and nonverbal audio events that were previously included in the active set of nonverbal audio events but are no longer selected are removed (e.g., deactivated).

At block 606, first audio data (e.g., audio data 506, 512, 516, 524, 528, and/or 532A) is detected using one or more sensor devices (e.g., microphones, bone vibration sensors, and/or other audio detection devices).

In response to detecting the first audio data and in accordance with a determination (block 608) that the first audio data include a first nonverbal audio event that is included in the active set of nonverbal audio events (e.g., by audio processing unit 353), at block 610, one or more actions are performed (e.g., by DA unit 350) based on the first nonverbal audio event. In response to detecting the first audio data and in accordance with a determination (block 608) that the first audio data does not include a first nonverbal audio event that is included in the active set of nonverbal audio events (e.g., by audio processing unit 353), at block 612, performance of the one or more actions based on the first nonverbal audio event is foregone.

In some embodiments, performing the one or more actions (610) includes causing an application to perform a respective task based on the first nonverbal audio event. In some examples, the first nonverbal audio event is associated with one or more tasks that can be performed using one or more applications (e.g., one or more actionable application intent). For example, a sharp exhale is associated with the task of initiating a workout and incrementing a rep counter for the workout in a fitness application (e.g., as described in FIGS. 5B-5C). As further examples, the sound of footfalls on a treadmill is associated with the task of initiating a running workout in the fitness application, the sound of an emergency siren is associated with the application tasks of pausing media playback and reducing playback volume, and/or the sound of placing a cooking dish on an oven rack is associated with the application task of starting a timer.

In some embodiments, performing the one or more actions (610) includes providing an output based on the first nonverbal audio event. In some examples, the output includes a display output, such as displaying or updating a user interface (e.g., 508A, 530A), an indicator (e.g., 518B), and/or other images, text, and graphical elements on a display of the computer system. In some examples, the output includes an audio output, such as a spoken output (e.g., 514B, 530B), alert sound (e.g., 514A), and/or media playback provided using one or more audio output devices (e.g., speakers and/or headphones). In some examples, the output includes a tactile (e.g., haptic) output (e.g., 508B). For example, the output provides a response to the first nonverbal audio event, conveys information about performance of the one or more actions, draws the user's attention to the response and/or performed actions, and/or provides follow-up suggestions to the user.

In some examples, the output based on the first nonverbal audio event includes an output generated by a digital assistant of the computer system (e.g., DA unit 350). For example, the digital assistant includes templates and/or AI models for generating textual outputs, speech outputs (e.g., using synthesized speech, e.g., 514B, 530B), display content (e.g., digital assistant indicator 518B), user interfaces, audio effects, and/or tactile effects. For example, the digital assistant of the computer system can generate conversational, natural-language outputs, such as spoken output 534, “Cook the onions for 22 more minutes, stirring occasionally, until golden.”

In some examples, performing the one or more actions (610) includes obtaining, via the one or more sensor devices, additional contextual information, wherein the additional contextual information is not included in the first set of contextual information. For example, as described with respect to FIGS. 5A-5C, the set of contextual information initially used to select the nonverbal audio triggers (e.g., 504) does not include contextual information determined from camera data, motion data, and biometric data, but camera data, motion data, and/or biometric data are collected and analyzed in response to detecting one of the active nonverbal audio triggers.

In some embodiments, the additional contextual information includes contextual information of a first type, and the first set of contextual information does not include contextual information of the first type. For example, the contextual information of the first type is contextual information detected using a first type of sensor (e.g., cameras), detected using a first sensor (e.g., a particular camera), and/or processed using a particular model or technique.

In some embodiments, performing the one or more actions (610) includes, after obtaining the additional contextual information, determining, based on the additional contextual information, whether a first set of task criteria is satisfied. For example, the first set of task criteria is associated with the first nonverbal audio event and/or a first candidate task associated with the first nonverbal audio event, for instance, defining additional conditions for confirming an inference drawn from detection of the first nonverbal audio event, confirming that task performance is appropriate based on the current context, and/or confirming which of a number of tasks associated with the first nonverbal audio event should be performed. In some examples, in accordance with a determination that the first set of task criteria is satisfied, a first task (e.g., the first candidate task associated with the first nonverbal audio event) is performed; and in accordance with a determination that the first set of task criteria is not satisfied, performance of the first task is foregone. In some embodiments, performing the one or more actions includes: after obtaining the additional contextual information, determining, based on the additional contextual information, whether a second set of task criteria is satisfied; in accordance with a determination that the second set of task criteria is satisfied, performing a second task; and in accordance with a determination that the second set of task criteria is not satisfied, foregoing performing the second task. For example, as described with respect to FIGS. 5B-5C, in response to detecting a sharp exhale indicating that the user is participating in a weightlifting exercise, camera data, biometric data, and/or motion data are collected and analyzed to determine whether the additional context indicates that the user is doing squats, bench presses, bicep curls, and/or not currently performing an exercise at all (e.g., a false positive). Depending on which of the additional context criteria are met, a workout for the corresponding confirmed exercise is initiated (e.g., or, if none of the additional context criteria are satisfied, performance of starting a workout is cancelled).

In some examples, after obtaining the additional contextual information (e.g., 510, 532B), a user input is detected (e.g., 516, 532A), and an output (e.g., 518A, 534) based on the additional contextual information is provided in response to detecting the user input. For example, after detecting the nonverbal audio event of food sizzling, image data (e.g., 532B) is analyzed to determine additional contextual information, such as the identity of the food cooking, the burner setting, and/or the state of the food, which is used to inform further outputs, such conveying cooking timer information to the user (e.g., as described with respect to FIGS. 5H-51), instructing next steps for a recipe, and/or otherwise describing and/or assisting with the cooking scene.

In some examples, the one or more sensor devices include one or more cameras, and obtaining the additional contextual information includes capturing visual information (e.g., image data 510) using the one or more cameras (e.g., as described with respect to FIG. 5C). For example, the one or more actions include activating, turning on, or otherwise changing a state of (e.g., a power state or capture rate) the one or more cameras to capture visual information. In some examples, the one or more actions include analyzing the additional captured visual information (e.g., camera data), for instance, to recognize objects, text, scenes, locations, and/or other visual features.

In some examples, the one or more sensor devices include one or more motion sensors (e.g., accelerometers, gyroscopes, magnetometers, GPS sensors, vibration sensors, LIDAR, IR motion sensors, odometers, and/or other motion sensors), and obtaining the additional contextual information includes capturing movement information using the one or more motion sensors (e.g., as described with respect to FIG. 5C). ISE, the one or more actions include activating, turning on, or otherwise changing a state of (e.g., a power state or capture rate) the one or more motion sensors to capture movement information. In some examples, the one or more actions include analyzing the additional captured motion information, for instance, to identify types of motion (e.g., walking, standing, exercising, driving, biking, climbing) and/or motion characteristics (e.g., amount of motion, scope of motion, speed of motion, and so forth).

In some examples, the one or more sensor devices include one or more biometric sensors (e.g., heart rate sensors, gaze detection sensors, blood oxygen sensors, temperature sensors, and/or other biometric sensors), and obtaining the additional contextual information includes capturing biometric information using the one or more biometric sensors. ISE, the one or more actions include activating, turning on, or otherwise changing a state of (e.g., a power state or capture rate) the one or more biometric sensors to capture biometric information.

In some examples, performing the one or more actions (610) includes selecting, based on the first nonverbal audio event, one or more audio events and populating an active set of audio events (e.g., 504) with the one or more audio events (e.g., as described with respect to FIG. 5C). ISE, additionally or alternatively, performing the one or more actions includes updating the active set of nonverbal audio events based on the first nonverbal audio event, including adding, removing, or otherwise changing the active set based on the detected nonverbal audio event. In some examples, the active set of audio events (e.g., 504) includes one or more verbal audio events and one or more nonverbal audio events (e.g., the active set of audio events includes the active set of nonverbal audio events as well as an active set of verbal audio events).

In some embodiments, the first audio data are detected while operating in a lower-power state (e.g., using power unit 360) (e.g., as further described with respect to method 700, below). For example, in the lower-power state, audio data are processed using a relatively low-power audio processing technique (e.g., cross-correlation) to detect the presence or absence of nonverbal audio events included in the active set of nonverbal audio events (e.g., 504), but the audio data are not processed using STT, NLP, and/or other more computationally-intensive (e.g., relatively high-power) audio recognition techniques.

In some embodiments, performing the one or more actions (610) includes causing the computer system to enter a higher-power state (e.g., using power unit 360) (e.g., as described with respect to FIG. 5G).

In some embodiments, while the computer system is in the lower-power state, at least one sensor device of the one or more sensor devices is in a lower-power sensor state (e.g., off, inactive, capturing at a lower rate, and/or capturing at a lower resolution), and while the computer system is in the higher-power state, the at least one sensor device of the one or more sensor devices is in a higher-power sensor state (e.g., on, active, capturing at a higher rate, and/or capturing at a higher resolution). For example, in the lower-power state, one or more cameras are not used to capture image data (e.g., as described with respect to FIG. 5A) and/or are used to capture image data at a low rate (e.g., once per ten seconds, one minute, five minutes, etc.) (e.g., as described with respect to FIG. 5F), and in the higher-power state, the one or more cameras are used to capture image data and/or are used to capture image data at a higher rate (e.g., once per second, 24 FPS, 60 FPS, etc.) (e.g., as described with respect to FIGS. 5G-5H). As another example, in the lower-power state, one or more audio sensors capture audio data at 8 kHz (e.g., or another relatively low sample rate at which the nonverbal audio triggers can still be detected), and in the higher-power state, the one or more audio sensors capture audio data at 44.1 kHz (e.g., or another relatively high sample rate, such as 48 kHz, 96 kHz, and/or another high-resolution audio sampling rate).

In some embodiments, in response to detecting the first audio data and in accordance with a determination that the first audio data include the first nonverbal audio event that is included in the active set of nonverbal audio events, a digital assistant session is initiated (e.g., as described with respect to FIG. 5G). For example, the first nonverbal audio event triggers a digital assistant session to begin “listening for” (e.g., detecting audio and performing STT and NLP processing) natural-language speech inputs and responding to detected inputs (e.g., without requiring an additional trigger, such as an explicit user request to interact with the digital assistant).

In some examples, after performing the one or more actions (610), the active set of nonverbal audio events (e.g., 504) is updated based on a second set of contextual information (e.g., the computer system selects (602), based on the second set of contextual information, one or more additional nonverbal audio events and populates (604) the active set of nonverbal audio events with the newly-selected events). In some examples, after performing the one or more actions (610), second audio data that includes the first nonverbal audio event is detected (606) via the one or more sensor devices, and, in response to detecting the second audio data that includes the first nonverbal audio event and in accordance with a determination (608) that the first nonverbal audio event is not included in the active set of nonverbal audio events, performance of the one or more actions based on the first nonverbal audio event is foregone (612). For example, as described with respect to FIGS. 5F-5G, after updating the set of audio triggers 504 to remove gym-related nonverbal audio events, device 500 does not respond to detection of a sharp exhale as it had previously responded while the sharp exhale was an active nonverbal trigger (e.g., at FIGS. 5B-5C).

In some embodiments, third audio data (e.g., 512A, 528) is detected (606) via the one or more sensors, and in response to detecting the third audio data and in accordance with a determination (608) that the third audio data include a second nonverbal audio event that is included in the active set of nonverbal audio events, one or more respective actions are performed, wherein the one or more respective actions are based on the second nonverbal audio event (e.g., as described with respect to FIGS. 5D and 5H). In some examples, the one or more respective actions include one or more different actions than the actions performed in response to detecting the first nonverbal audio event. For example, as described with respect to FIGS. 5B-5D, incrementing a workout rep counter is performed in response to detecting a sharp exhale, while incrementing a workout set counter (e.g., and resetting the workout rep counter) is performed in response to detecting the sound of re-racking a barbell. In some examples, the one or more respective actions include one or more of the same actions as the actions performed in response to detecting the first nonverbal audio event. For example, actions such as capturing and analyzing additional context information, providing a notification chime, and/or initiating a digital assistant session (e.g., and displaying indicator 518B) may be performed in response to a variety of different active nonverbal audio events.

FIG. 7 is a flow diagram of a method 700 for providing low-power action assistance using contextual information, according to some examples. In some examples, method 700 is performed at a computer system (e.g., computer system 101 in FIG. 1, device 500) that is in communication with one or more sensor devices (e.g., image sensors, light sensors, depth sensors, tactile sensors, orientation sensors, proximity sensors, temperature sensors, location sensors, motion sensors, velocity sensors, audio sensors, and/or biometric sensors), including one or more audio sensors and one or more cameras. In some examples, method 700 is governed by instructions that are stored in a non-transitory (or transitory) computer-readable storage medium and that are executed by one or more processors of a computer system, such as the one or more processing unit(s) 302 of computer system 101 (e.g., controller 110 in FIG. 1). In some examples, the operations of method 700 are distributed across multiple computer systems, e.g., a computer system and a separate server system. Some operations in method 700 are, optionally, combined, the orders of some operations are, optionally, changed, and some operations are, optionally, omitted.

At block 702, a first set of contextual information (e.g., current contextual information, e.g., provided by context unit 352) is retrieved. For example, the first set of contextual information includes and/or is based on data from data obtaining unit 341 (e.g., 502, 506, 510, 512, 516, 520, 524, 528, 532A, and/or 532B), from the computer system (e.g., operating system, application, and/or digital assistant data), and/or from data processing (e.g., from context unit 352 and/or audio processing unit 353).

In accordance with determining (704) (e.g., using context unit 352), based on the first set of contextual information, that a context state is changed (e.g., in response to detecting a change to the context state based on the first set of contextual information), an active set of one or more audio events (e.g., 504) is updated (706) based on the first set of contextual information (e.g., as described with respect to FIG. 5F). For instance, as described with respect to FIG. 5A, in accordance with a determination that a context state has changed to indicate the user is at the gym, audio events (e.g., triggers) related to the gym are activated, and as described with respect to FIG. 5F, in accordance with a determination that a context state has changed to indicate the user is at home in the kitchen (e.g., and no longer at the gym), audio events related to cooking are activated. In some examples, in accordance with determining (704) that the context state is not changed based on the first set of contextual information (e.g., if no change to the context state is detected), the active set of one or more audio events is not updated based on the first set of contextual information (e.g., the active audio events remain unchanged).

At block 708, first audio data (e.g., audio data 506, 512, 516, 524, 528, and/or 532A) is detected via the one or more audio sensors (e.g., microphones, bone vibration sensors, and/or other audio detection devices).

In response to detecting the first audio data and in accordance with a determination (710) that the first audio data include a first audio event that is included in the active set of one or more audio events, at block 712, first visual information (e.g., 510, 532B) is obtained via the one or more cameras. For example, image data 510 is captured at FIG. 5C in response to detecting a sharp exhale at FIG. 5B. For example, image data 532B is captured at FIG. 5I in response to detecting the sizzle at FIG. 5H, in response to detecting the sound of the burner igniting at FIG. 5G (e.g., as part of an initiated digital assistant session), and/or in response to detecting the verbal audio trigger “recipe” in audio data 532A.

In response to detecting the first audio data and in accordance with a determination (710) that the first audio data include the first audio event that is included in the active set of one or more audio events, at block 714, one or more actions are performed based on the first visual information. For example, as described with respect to FIG. 5C, the workout rep counter (e.g., 508A) is updated to a squat rep counter and the fitness application logs a weight of 85 pounds based on analysis of image data 510, which shows the user performing a squat with 85 pounds of weight. As another example, as described with respect to FIG. 5I, a natural-language digital assistant output, “Cook the onions for 22 more minutes, stirring occasionally, until golden” (e.g., 534) is generated in response to a user request based on analysis of image data 532B, which shows a written recipe and onions cooking in a pan.

In response to detecting the first audio data and in accordance with a determination (710) that the first audio data does not include the first audio event that is included in the active set of one or more audio events, at block 716, visual information is not obtained from the one or more cameras and performance of the one or more actions based on obtained visual context is foregone.

In some examples, when the first audio data are detected, the active set of one or more audio events (e.g., 504) includes one or more nonverbal audio events (e.g., as described with respect to block 602 in FIG. 6). In some embodiments, when the first audio data are detected, the active set of one or more audio events (e.g., 504) includes one or more verbal audio events.

In some embodiments, retrieving the first set of contextual information includes capturing, via the one or more sensor devices, sensor data (e.g., 502, 506, 510, 512, 516, 520, 524, 528, 532A, and/or 532B). For example, the sensor data includes audio data, image data, motion data, location data, biometric data, and/or other data detected from the 3D scene.

In some examples, capturing the sensor data includes capturing camera data (e.g., 520) via a first camera of the one or more cameras (e.g., as described with respect to FIG. 5F). For example, while operating in a lower-power state, the first set of contextual information is determined using image data captured using a lower-resolution camera and/or using image data captured at a relatively low rate (e.g., once per ten seconds, one minute, five minutes, etc.).

In some examples, while capturing the sensor data, capturing camera data via a second camera of the one or more cameras is foregone (e.g., as described with respect to FIG. 5A). For example, while operating in a lower-power state, the first set of contextual information is determined without capturing image data using a higher-resolution camera and/or without capturing new image data (e.g., using only camera data captured at the relatively low rate). Accordingly, in some examples, image data is not used when periodically updating the current context information, and in some examples, image data is used to periodically update the current context information, but the image data may be captured and/or analyzed infrequently (e.g., absent detection of an active audio trigger).

In some examples, while a lower-power state is enabled (e.g., via power unit 360), capturing the sensor data includes capturing sensor data via a first sensor device of the one or more sensor devices at a first rate (e.g., a first capture frequency and/or sample rate) (e.g., as described with respect to FIG. 5F). For example, the first rate is a relatively low rate, such as polling the sensor for new data once every ten seconds, once per minute, or once per five minutes in order to reduce the amount of power used by the sensor in order to periodically update the current context. For example, different sensors may be polled at different rates while in the low-power state, for instance, using an audio sensor to detect audio at 8 kHz, using a camera to capture an image every ten seconds, and/or using a biometric sensor to detect biometric information once per minute.

In some examples, in response to detecting the first audio data and in accordance with a determination that the first audio data include the first audio event that is included in the active set of one or more audio events, a higher-power state is enabled (e.g., via power unit 360) (e.g., as described with respect to FIGS. 5G-5H). In some examples, while the higher-power state is enabled, capturing the sensor data includes capturing sensor data from the first sensor device of the one or more sensor devices at a second rate, wherein the second rate is higher than the first rate. For example, the second rate is a relatively high rate, such as using an audio sensor to detect audio at 44.1 kHz, using a camera to capture video data at 24 FPS, and/or using a biometric sensor to detect biometric information four times per second in order to periodically update the current context.

In some examples, in response to obtaining the first visual information, the first set of contextual information is updated to include the first visual information (e.g., as described with respect to FIGS. 5C and 5I). In some examples, after updating the first set of contextual information, a second change to the context state is determined (704) based on the first set of contextual information. In some examples, in response to determining the second change to the context state based on the first set of contextual information, the active set of one or more audio events is updated (706) based on the first set of contextual information. For example, after capturing camera data in response to detecting an active audio trigger, the captured camera data is analyzed to update the current context information, including (e.g., as illustrated in FIG. 7) checking for further changes to the current context state and updating the active set of audio triggers based on the camera data if the captured camera data indicates a change to the context state. For example, as described with respect to FIG. 5C, upon capturing and analyzing image data 510 to determine that the user is performing a squat exercise, the set o audio triggers 504 is updated to include the sound of re-racking the barbell being used for the squat exercise and words related to the squat exercise (e.g., “rep,” “set,” and “squat”).

In some examples, obtaining the first visual information includes capturing, via the one or more cameras, one or more frames of camera data. In some examples, obtaining the first visual information includes capturing, via the one or more cameras, video data. For example, while the cameras are inactive (e.g., not being used to capture any image data) and/or capturing image data at a relatively low capture rate (e.g., once per 10 seconds, one minute, five minutes, etc.), detecting an active audio event triggers the computer system to immediately begin capturing image data (e.g., additional frames) and/or video data (e.g., enabling a camera feed).

In some examples, obtaining the first visual information includes capturing, via the one or more cameras, first camera data (e.g., 510 and/or 532B) and processing the first camera data to obtain the first visual information, wherein the first visual information includes first image recognition results based on the first camera data (e.g., as described with respect to FIGS. 5C and 5I). For example, the camera data is processed using optical character recognition (OCR), edge detection, algorithmic image processing, and/or machine vision (e.g., using a neural network and/or transformer model) to identify information about and from a 3D scene, such as detecting particular objects, types of objects, text, symbols, people, locations, and/or other visual features. In some examples, while in a lower-power mode, camera data is captured using the one or more cameras (e.g., at a relatively low rate), but the camera data is only processed to obtain visual information in response to detecting an active audio trigger.

In some examples, performing the one or more actions based on the first visual information includes identifying, based on the first image recognition results, a first intent object (e.g., a software object or data structure corresponding to a user intent) and performing a first action, wherein the first action corresponds to the first intent object (e.g., as described with respect to FIGS. 5C and 5G). For example, the intent object includes instructions and/or logic for performing a computing task using the computer system, the DA, an application, and/or another service. For example, in order to cause the fitness application to track a squat workout identified based on image data 510 (e.g., as described with respect to FIG. 5C), the DA identifies and provides an intent object corresponding to tracking a squat workout to the fitness application.

In some examples, performing the one or more actions based on the first visual information includes identifying, based on the first image recognition results, a first parameter value and performing a second action using the first parameter value. For example, at FIG. 5C, image data 510 is processed to determine parameter values for the type of weightlifting exercise (e.g., squat) and the amount of weight being used (e.g., 85 pounds) for performing the action of tracking the workout in the fitness application. For example, at FIG. 5I, image data 532B is processed to determine parameter values for the action of providing a natural-language digital assistant response (e.g., 534) to a user request, in particular, identifying the ingredient being cooked in the pan (onions) and detecting and interpreting the text of the recipe (instructing the user to brown the onions for 25 minutes).

In some examples, first action metadata is identified based on the first image recognition results, and the first action metadata is associated with a third action of the one or more actions. In some examples, after associating the first action metadata with the third action of the one or more actions, a user input related to the third action of the one or more actions is detected. In some examples, in response to detecting the user input related to the third action of the one or more actions, a follow-up action based on the first action metadata is performed. For example, at FIG. 5C, the workout rep counter is annotated with metadata indicating that the counter is for a squat exercise. Accordingly, in response to the user input “How many reps was that?,” the DA provides the response “You have completed one set of six squats” based on the specifically-identified exercise. For example, at FIG. 5I, cooking timer 530A is annotated with metadata indicating that the timer corresponds to the cook time of the onions in the pan identified from image data 532B. As another example, at FIG. 5I, cooking timer 530A and/or the digital assistant session is annotated with the recipe text extracted from image data 532B, allowing the recipe to be referenced in future digital assistant interactions without needing to capture additional image data. Accordingly, in response to a user input such as “How much time left on the onions?,” the DA can identify cooking timer 530A as the relevant timer for the onions and/or analyze the recipe text to determine how much longer the onions should cook to provide a response.

In some examples, performing the one or more actions based on the first visual information includes causing an application to perform a respective action (e.g., as described with respect to tracking the squat exercise in the fitness application at FIG. 5C). As further examples, based on analysis of image data, a reminders application can create a reminder based on identified text, a media player application can pause video playback based on image data indicating that a pet has jumped in front of the user's television, and/or a timer application can initiate a cooking timer based on image data indicating the type of dish being cooked.

In some examples, performing the one or more actions based on the first visual information includes providing an output based on the first visual information. In some examples, the output includes a display output, such as displaying or updating a user interface (e.g., 508A, 530A), an indicator (e.g., 518B), and/or other images, text, and graphical elements on a display of the computer system. In some examples, the output includes an audio output, such as a spoken output (e.g., 514B, 530B, 534), alert sound (e.g., 514A), and/or media playback provided using one or more audio output devices (e.g., speakers and/or headphones). In some examples, the output includes a tactile (e.g., haptic) output (e.g., 508B). For example, the output provides a response to the first nonverbal audio event, conveys information about performance of the one or more actions, draws the user's attention to the response and/or performed actions, and/or provides follow-up suggestions to the user.

In some examples, the output based on the first visual information includes an output generated by a digital assistant of the computer system (e.g., DA unit 350). For example, the digital assistant includes templates and/or AI models for generating textual outputs, speech outputs (e.g., using synthesized speech, e.g., 514B, 530B, 534), display content (e.g., digital assistant indicator 518B), user interfaces, audio effects, and/or tactile effects. For example, the digital assistant of the computer system can generate conversational, natural-language outputs, such as spoken output 534, “Cook the onions for 22 more minutes, stirring occasionally, until golden.”

As described above, one aspect of the present technology is the gathering and use of data available from various sources to facilitate user interactions with a three-dimensional scene. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to perform actions to assist a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of performing actions for the user, the present technology can be configured to allow users to select to “opt in” or “opt out” of participation in the collection of personal information data during registration for services or anytime thereafter. In another example, users can select not to provide personal information data based on which actions are generated and/or performed. In yet another example, users can select to limit the length of time for which such data is maintained. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, actions can be generated and performed based on non-personal information data or a bare minimum amount of personal information, such as the content being requested by the device associated with a user, other non-personal information available to the service, or publicly available information.

What is claimed is:

1. A computer system configured to communicate with one or more sensor devices, including one or more audio sensor devices and one or more cameras, the computer system comprising:
one or more processors; and
memory storing one or more programs configured to be executed by the one or more processors, the one or more programs including instructions for:
retrieving a first set of contextual information;
determining a first change to a context state based on the first set of contextual information;
in response to determining the first change to the context state, updating, based on the first set of contextual information, an active set of one or more audio events;
detecting, via the one or more audio sensors, first audio data; and
in response to detecting the first audio data:
in accordance with a determination that the first audio data include a first audio event that is included in the active set of one or more audio events:
obtaining, via the one or more cameras, first visual information; and
performing one or more actions based on the first visual information.

2. The computer system of claim 1, wherein, when the first audio data are detected, the active set of one or more audio events includes one or more nonverbal audio events.

3. The computer system of claim 1, wherein, when the first audio data are detected, the active set of one or more audio events includes one or more verbal audio events.

4. The computer system of claim 1, wherein retrieving the first set of contextual information includes capturing, via the one or more sensor devices, sensor data.

5. The computer system of claim 4, wherein capturing the sensor data includes capturing camera data via a first camera of the one or more cameras.

6. The computer system of claim 4, the one or more programs further including instructions for:
while capturing the sensor data, foregoing capturing camera data via a second camera of the one or more cameras.

7. The computer system of claim 4, wherein capturing the sensor data includes:
while a lower-power state is enabled, capturing sensor data via a first sensor device of the one or more sensor devices at a first rate.

8. The computer system of claim 7, the one or more programs further including instructions for:
in response to detecting the first audio data and in accordance with a determination that the first audio data include the first audio event that is included in the active set of one or more audio events, enabling a higher-power state; and
while the higher-power state is enabled, capturing sensor data from the first sensor device of the one or more sensor devices at a second rate, wherein the second rate is higher than the first rate.

9. The computer system of claim 1, the one or more programs further including instructions for:
in response to obtaining the first visual information, updating the first set of contextual information to include the first visual information.

10. The computer system of claim 9, the one or more programs further including instructions for:
after updating the first set of contextual information, determining a second change to the context state based on the first set of contextual information; and
in response to determining the second change to the context state based on the first set of contextual information, updating, based on the first set of contextual information, the active set of one or more audio events.

11. The computer system of claim 1, wherein obtaining the first visual information includes capturing, via the one or more cameras, one or more frames of camera data.

12. The computer system of claim 1, wherein obtaining the first visual information includes capturing, via the one or more cameras, video data.

13. The computer system of claim 1, wherein obtaining the first visual information includes:
capturing, via the one or more cameras, first camera data; and
processing the first camera data to obtain the first visual information, wherein the first visual information includes first image recognition results based on the first camera data.

14. The computer system of claim 13, wherein performing the one or more actions based on the first visual information includes:
identifying, based on the first image recognition results, a first intent object; and
performing a first action, wherein the first action corresponds to the first intent object.

15. The computer system of claim 13, wherein performing the one or more actions based on the first visual information includes:
identifying, based on the first image recognition results, a first parameter value; and
performing a second action using the first parameter value.

16. The computer system of claim 13, the one or more programs further including instructions for:
identifying, based on the first image recognition results, first action metadata; and
associating the first action metadata with a third action of the one or more actions.

17. The computer system of claim 16, the one or more programs further including instructions for:
after associating the first action metadata with the third action of the one or more actions, detecting a user input related to the third action of the one or more actions; and
in response to detecting the user input related to the third action of the one or more actions, perform a follow-up action based on the first action metadata.

18. The computer system of claim 1, wherein performing the one or more actions based on the first visual information includes causing an application to perform a respective action.

19. The computer system of claim 1, wherein performing the one or more actions based on the first visual information includes providing an output based on the first visual information.

20. The computer system of claim 19, wherein the output based on the first visual information includes an output generated by a digital assistant of the computer system.

21. A non-transitory computer-readable storage medium storing one or more programs configured to be executed by one or more processors of a computer system that is in communication with one or more sensor devices, including one or more audio sensor devices and one or more cameras, the one or more programs including instructions for:
retrieving a first set of contextual information;
determining a first change to a context state based on the first set of contextual information;
in response to determining the first change to the context state, updating, based on the first set of contextual information, an active set of one or more audio events;
detecting, via the one or more audio sensors, first audio data; and
in response to detecting the first audio data:
in accordance with a determination that the first audio data include a first audio event that is included in the active set of one or more audio events:
obtaining, via the one or more cameras, first visual information; and
performing one or more actions based on the first visual information.

22. A method, comprising:
at a computer system that is in communication with one or more sensor devices, including one or more audio sensor devices and one or more cameras:
retrieving a first set of contextual information;
determining a first change to a context state based on the first set of contextual information;
in response to determining the first change to the context state, updating, based on the first set of contextual information, an active set of one or more audio events;
detecting, via the one or more audio sensors, first audio data; and
in response to detecting the first audio data:
in accordance with a determination that the first audio data include a first audio event that is included in the active set of one or more audio events:
obtaining, via the one or more cameras, first visual information; and
performing one or more actions based on the first visual information.
